(19) United States
(12) Patent Application Publication
(10) Pub. No.: US 2019/0109935 A1
(43) Pub. Date: Apr. 11, 2019

(54) MOBILE DEVICE, METHOD FOR CONTROLLING MOBILE DEVICE, DEVICE FOR CONTROLLING MOBILE DEVICE, AND NON-TRANSITORY COMPUTER READABLE STORAGE MEDIUM

(71) Applicant: KYOCERA Corporation, Kyoto-shi, Kyoto (JP)

(72) Inventors: Tomomi NAGAO, Kawasaki-shi, Kanagawa (JP); Hidetoshi HACHIYA, Yokohama-shi, Kanagawa (JP)

(21) Appl. No.: 16/088,818

(22) PCT Filed: Mar. 17, 2017
(86) PCT No.: PCT/JP2017/010822

§ 371 Date: Sep. 27, 2018

(30) Foreign Application Priority Data
Mar. 28, 2016 (JP) 2016-063781

(51) Int. Cl. H04M 1/725; H01M 10/46; H04M 1/02; H04M 1/73

(52) U.S. Cl. CPC H04M 1/72519; H04M 1/73; H04M 1/02; H01M 10/465

(57) ABSTRACT

A mobile device includes an outer package, a plurality of photoelectric converters, and at least one processor. The plurality of photoelectric converters are adjacently located and each of which generates power based on light incident on one surface of the outer package. The at least one processor switches operation modes of the mobile device in response to a fact that an output generated correspondingly to light received at each one of a preset number of photoelectric converters among the plurality of photoelectric converters is a low output that meets criterion conditions.

### CROSS-REFERENCE TO RELATED APPLICATION

The present application is a National Phase entry based on PCT Application No. PCT/JP2017/010822 filed on Mar. 17, 2017, entitled “PORTABLE APPARATUS, METHOD FOR CONTROLLING PORTABLE APPARATUS, DEVICE FOR CONTROLLING PORTABLE APPARATUS, AND CONTROL PROGRAM” which claims the benefit of Japanese Patent Application No. 2016-063781, filed on Mar. 28, 2016, entitled “MOBILE DEVICE, METHOD FOR CONTROLLING MOBILE DEVICE, DEVICE FOR CONTROLLING MOBILE DEVICE AND CONTROL PROGRAM”.

### FIELD

The present disclosure relates to a mobile device, a method for controlling a mobile device, a device for controlling a mobile device, and a non-transitory computer readable storage medium.

### BACKGROUND

Hitherto, a mobile device installed with a solar cell module has been proposed.

### SUMMARY

A mobile device, a method for controlling a mobile device, a device for controlling a mobile device, and a non-transitory computer readable storage medium are disclosed.

In one embodiment, a mobile device includes an outer package, a plurality of photoelectric converters, and at least one processor. The plurality of photoelectric converters are adjacently located and each of which generates power based on light incident on one surface of the outer package. The at least one processor is configured to switch operation modes of the mobile device in response to a fact that an output generated correspondingly to light received at each one of a preset number of photoelectric converters among the plurality of photoelectric converters is a low output that meets criterion conditions.

In one embodiment, a method for controlling a mobile device includes determining that an output generated correspondingly to light received at each one of a preset number of photoelectric converters among a plurality of photoelectric converters that are adjacently located and each generate power based on light incident on one surface of an outer package of the mobile device is a low output that meets criterion conditions, and switching operation modes of the mobile device in response to determination made that each output of the preset number of photoelectric converters is the low output.

In one embodiment, a device for controlling a mobile device includes a storage medium, and at least one processor. The storage medium stores a program. The at least one of processor configured to execute switching processing of switching operation modes of the mobile device by executing the program, in response to a fact that an output generated correspondingly to light received at each one of a preset number of photoelectric converters among a plurality of photoelectric converters that are adjacently located and each generate power based on light incident on one surface of an outer package of the mobile device is a low output that meets criterion conditions.

In one embodiment, a non-transitory computer readable storage medium stores a control program The control program makes a mobile device determine that an output generated correspondingly to light received at each one of a preset number of photoelectric converters among a plurality of photoelectric converters that are adjacently located and each generate power based on light incident on one surface of an outer package of the mobile device is a low output that meets criterion conditions, and switch operation modes of the mobile device in response to determination made that each output of the preset number of photoelectric converters is the low output.

### BRIEF DESCRIPTION OF DRAWINGS

FIG. 1 illustrates a perspective view schematically showing one example of external appearance of a mobile device.

FIG. 2 illustrates a back view schematically showing one example of external appearance of the mobile device.

FIG. 3 illustrates a block diagram schematically showing one example of an electrical configuration of the mobile device.

FIG. 4 illustrates a diagram schematically showing one example of a manner of disposing a solar panel.

FIG. 5 illustrates a diagram schematically showing one example of a configuration of the solar panel.

FIG. 6 illustrates a diagram schematically showing one example of an internal configuration of a controller.

FIG. 7 illustrates one example of conditions where the user uses the mobile device.

FIG. 8 illustrates another example of conditions where the user uses the mobile device.

FIG. 9 illustrates one example of a light reception state of the solar panel.

FIG. 10 illustrates another example of a light reception state of the solar panel.

FIG. 11 illustrates a display mode of information in a display.

FIG. 12 illustrates one example of a display mode of information in the display.

FIG. 13 illustrates another example of a display mode of information in the display.

FIG. 14 illustrates yet another example of a display mode of information in the display.

FIG. 15 illustrates one example in which notification modes are switched during incoming.

FIG. 16 illustrates one example in which notification modes are switched during incoming.

FIG. 17 illustrates one example in which notification modes are switched during incoming.

FIG. 18 illustrates another example in which notification modes are switched during incoming.

FIG. 19 illustrates another example in which notification modes are switched during incoming.

FIG. 20 illustrates another example in which notification modes are switched during incoming.

FIG. 21 illustrates a flowchart concerning one example of processing of switching operation modes.

FIG. 22 illustrates a flowchart concerning another example of processing of switching operation modes.

FIG. 23 illustrates one example in which operation modes are switched during incoming.

FIG. 24 illustrates another example in which operation modes are switched during incoming.

FIG. 25 illustrates a diagram schematically showing one example of a manner of disposing the solar panel.

FIG. 26 illustrates a diagram schematically showing one example of a configuration of the solar panel.

FIG. 27 illustrates a back view schematically showing one example of external appearance of a mobile device.

### DETAILED DESCRIPTION

Now, one example and various modifications of an embodiment will be described with reference to the drawings. Note that, the same reference symbols are given to components having similar configuration and function in the drawings, and overlapping description will be omitted in the following description. Further, the drawings are schematically illustrated, and the size, positional relation, etc. of various structures in each drawing may be appropriately changed.

<(1) One Example of Embodiment>

<(1-1) One Example of External Appearance of Mobile Device>

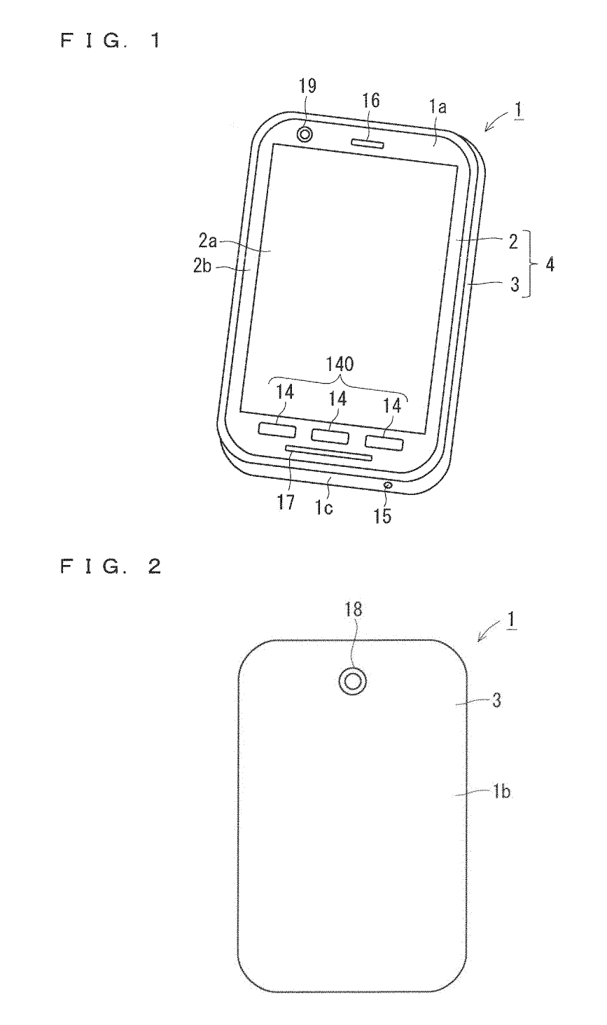

FIG. 1 is a perspective view schematically illustrating one example of external appearance of a mobile device 1. FIG. 2 is a back view schematically illustrating one example of external appearance of the mobile device 1. The mobile device 1 is, for example, a portable electronic device such as a smartphone. For example, the mobile device 1 may be capable of communicating with other communication devices via a base station, a server and the like.

As illustrated in FIG. 1 and FIG. 2, a mobile device 1 includes an outer package (housing) 4. For example, the outer package 4 includes a cover panel 2 and a device case 3. The cover panel 2 is located on a front surface 1a of the mobile device 1, and is attached to the device case 3. The shape of the outer package 4 of the mobile device 1 is, for example, a substantially rectangular plate-like shape in plan view.

On a back surface side of the cover panel 2, a display panel 121, a touch panel 130, and a solar panel 210 are located. The cover panel 2, the display panel 121, the touch panel 130, and the solar panel 210 are, for example, located to be overlapped substantially in parallel with one another. Specifically, for example, the touch panel 130 is attached to a back surface of the cover panel 2, the solar panel 210 is attached to a back surface of the touch panel 130, and the display panel 121 is attached to a back surface of the solar panel 210. Note that, the solar panel 210 may be, for example, located on or above the display panel 121 directly or with intermediation of another transparent layer.

The cover panel 2 has a property of transmitting light (also referred to as transparency) in a specific wavelength range. Light in a specific wavelength range may include, for example, visibly unrecognizable light (also referred to as invisible light) as well as visible light. Invisible light may include, for example, ultraviolet light, infrared light and the like. Further, on the cover panel 2, there is a display screen 2a on which various types of information such as letters, symbols, and graphics displayed by the display panel 121 are displayed. Most part of a peripheral edge portion 2b of the cover panel 2 surrounding the display screen 2a is black because the part is attached with a film or the like, for example. With this, most part of the peripheral edge portion 2b of the cover panel 2 is a non-display region where various types of information displayed by the display panel 121 are not displayed.

The touch panel 130 has transparency. The touch panel 130 can detect contact or proximity of a pointer (such as a finger of a user) on or toward the display screen 2a. The user can issue various instructions to the mobile device 1 by operating the display screen 2a with a pointer.

The solar panel 210 has, for example, a function as a solar cell capable of generating power based on light in a predetermined wavelength range that is incident on the solar panel 210 through the cover panel 2. Light in a predetermined wavelength range may include, for example, ultraviolet light and the like. That is, for example, in the solar panel 210, an output can be obtained correspondingly to reception of light in a predetermined wavelength range. Here, the output includes, for example, voltage, current, and electric power. Then, the electric power obtained through power generation in the solar panel 210 can be, for example, used in the mobile device 1. With this, the solar panel 210 can be, for example, used as a power source of the mobile device 1. Further, the solar panel 210 is a transparent panel having a property of transmitting light in another predetermined wavelength range, which is different from the predetermined wavelength range. Light in another predetermined wavelength range may include, for example, visible light. With this, visible light emitted from the display panel 121 can be transmitted through the solar panel 210 and the like. As a result, various types of information can be visibly output onto the display screen 2a by the display panel 121.

Further, as illustrated in FIG. 1, for example, in an upper end portion of the cover panel 2, there is a second-lens transparent member 19 provided so that a lens of a second camera 190 to be described later is visibly recognizable from the outside of the mobile device 1. Further, a receiver hole 16 is formed in the vicinity of the upper end portion of the cover panel 2. Further, a speaker hole 17 is formed in the vicinity of a lower end portion of the cover panel 2. Further, a microphone hole 15 is formed in a bottom surface 1c of the mobile device 1, i.e., a bottom surface (a lower side surface) of the device case 3.

Further, as illustrated in FIG. 2, for example, in the vicinity of an upper end portion of a back surface of the device case 3, which is part of a back surface 1b of the outer package 4 of the mobile device 1, there is a first-lens transparent member 18 provided so that a lens of a first camera 180 to be described later is visibly recognizable from the outside of the mobile device 1.

Inside the device case 3, there is an operation button group 140 that includes a plurality of operation buttons 14. Each operation button 14 is a hardware button, such as a push button. The operation button may be referred to as an “operation key” or a “key.” Each operation button 14 is, for example, exposed at the vicinity of a lower end portion of the cover panel 2. The user can issue various instructions to the mobile device 1 by operating respective operation buttons 14 with a finger or the like.

The plurality of operation buttons 14 include, for example, a home button, a back button, and a history button. The home button is an operation button for displaying a home screen (a default screen) in the display screen 2a. The back button is an operation button for switching the display of the display screen 2a into a previous screen. The history button is an operation button for displaying in the display screen 2a a list of applications that have been executed in the mobile device 1.

<(1-2) One Example of Electrical Configuration of Mobile Device>

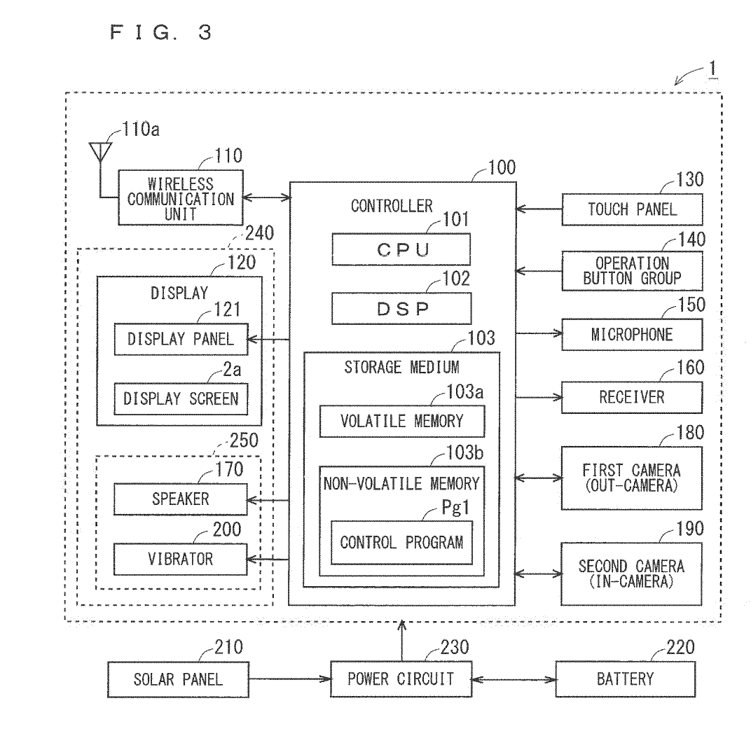

FIG. 3 is a block diagram schematically illustrating one example of an electrical configuration of the mobile device 1. As illustrated in FIG. 3, the mobile device 1 includes a controller 100, a wireless communication unit 110, a display 120, a touch panel 130, a solar panel 210, an operation button group 140, a speaker 170, and a vibrator 200. Further, the mobile device 1 includes a microphone 150, a receiver 160, a first camera 180, a second camera 190, a power circuit 230, and a battery 220. The components of the above are accommodated inside the outer package 4 of the mobile device 1.

The controller 100 is, for example, a type of arithmetic processing unit, and includes, for example, a central processing unit (CPU) 101, a digital signal processor (DSP) 102, and a storage medium 103 each being an electrical circuit. The controller 100 can, for example, integrally manage operation of the mobile device 1 by controlling other components of the mobile device 1. The mobile device 1 may further include, for example, a co-processor such as a system-on-a-chip (SoC), a micro control unit (MCU), and a field-programmable gate array (FPGA). Further, the mobile device 1 may perform various types of control by activating both of the central processing unit (CPU) and the co-processor in cooperation, or by selectively using either of those.

The controller 100 includes at least one processor for providing control and processing capability to perform various functions as described in further detail below.

In accordance with various embodiments, the at least one processor may be implemented as a single integrated circuit (IC) or as multiple communicatively coupled IC's and/or discrete circuits. It is appreciated that the at least one processor can be implemented in accordance with various known technologies.

In one embodiment, the processor includes one or more circuits or units configurable to perform one or more data computing procedures or processes by executing instructions stored in an associated memory, for example. In other embodiments, the processor may be implemented as firmware (e.g., discrete logic components) configured to perform one or more data computing procedures or processes.

In accordance with various embodiments, the processor may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

The storage medium 103 includes non-transitory storage medium such as read only memory (ROM) and random access memory (RAM) that can be read by a CPU 101 and a DSP 102. The ROM of the storage medium 103 is, for example, flash ROM (flash memory) being non-volatile memory 103b. Further, the RAM of the storage medium 103 is, for example, volatile memory 103a. The storage medium 103 stores a main program, a plurality of application programs (hereinafter also simply referred to as “applications”), and the like for controlling the mobile device 1. Various functions of the controller 100 are implemented by the CPU 101 and the DSP 102 executing various programs in the storage medium 103. The storage medium 103 stores, for example, a call application for performing a voice call and a video call, and an image capturing application for capturing a still image or a moving image using the first camera 180 or the second camera 190. Further, applications stored in the storage medium 103 include, for example, a control program Pg1 for controlling the mobile device 1.

Note that, the storage medium 103 may include a non-transitory recording medium other than ROM and RAM that can be read by a computer. Further, the storage medium 103 may include, for example, a small-sized hard disk drive and a solid state drive (SSD). Further, a storage medium different from the storage medium 103 may be provided. The storage medium may be located outside the controller 100. The storage destination of information to be described later may be the storage medium 103 or another storage medium. Further, all of the functions of the controller 100 or some of the functions of the controller 100 may be implemented by hardware that does not require software to implement such functions. In short, the controller 100 may be formed by a circuit. Further, the configuration of the controller 100 is applicable to other controllers to be described later.

The wireless communication unit (also referred to as a communication circuit) 110 is what is called a communication interface, and includes an antenna 110a. The wireless communication unit 110 can receive, for example, a signal from a communication device different from the mobile device 1 or a signal from a communication device such as a web server connected to the internet, at the antenna 110a via a base station, for example. The wireless communication unit 110 can subject the signal received at the antenna 110a to amplification processing and down-conversion, and can then output the signal to the controller 100. The controller 100 can subject, for example, the received incoming signal to demodulation processing or the like, and can thereby acquire various pieces of information (e.g., information of sound signals representing voice, music, or the like) that are contained in the signal.

Further, the wireless communication unit 110 can subject a transmission signal generated at the controller 100 to up-conversion and amplification processing, and can then wirelessly transmit the processed transmission signal from the antenna 110a. The transmission signal from the antenna 110a is, for example, received by a mobile device other than the mobile device 1 or by a communication device such as a web server connected to the internet via a base station.

The display 120 includes the display panel 121 and the display screen 2a. The display panel 121 is, for example, located on the side of the front surface 1a being one surface of the outer package 4. For example, a liquid crystal panel or an organic electro luminescence (EL) panel may be adopted as the display panel 121. The display panel 121 can display various types of information such as letters, symbols, and graphics by being controlled by the controller 100. The various types of information displayed by the display panel 121 are displayed on the display screen 2a. With this, the display 120 can, for example, visibly output information.

The touch panel 130 is, for example, a projected capacitive touch panel. The touch panel 130 can, for example, detect operation performed on the display screen 2a by a pointer such as a finger. When the user operates the display screen 2a with a pointer such as a finger, an electrical signal corresponding to the operation is input into the controller 100 from the touch panel 130. With this, based on the electrical signal from the touch panel 130, the controller 100 can specify the detail of the operation performed on the display screen 2a and can then perform processing corresponding to the detail. Note that, the user can also issue various instructions to the mobile device 1 by operating the display screen 2a with a pointer other than a finger, for example, with an electrostatic touch panel pen such as a stylus pen.

When operated by the user, each operation button 14 of the operation button group 140 can output to the controller 100 an operation signal indicating that the operation button 14 has been operated. With this, the controller 100 can determine whether or not the operation button 14 has been operated based on the operation signal from each operation button 14. The controller 100 can perform processing corresponding to the operated operation button 14. Note that, each operation button 14 may be a software button to be displayed on the display screen 2a, instead of a hardware button such as a push button. In this case, operation on a software button is detected by the touch panel 130, and the controller 100 can thereby perform processing corresponding to the operated software button.

The microphone 150 can, for example, convert incoming sound from the outside of the mobile device 1 into an electrical sound signal, and can then output the signal to the controller 100. Sound from the outside of the mobile device 1 is, for example, taken into the mobile device 1 through the microphone hole 15 located on the bottom surface (lower side surface) 1c of the device case 3, and is then input into the microphone 150.

The speaker 170 can output voice, for example. The speaker 170 is a dynamic speaker, for example. For example, in the speaker 170, the electrical sound signal from the controller 100 can be converted into sound to be output therefrom. Sound output from the speaker 170 is, for example, output to the outside of the mobile device 1 through the speaker hole 17 formed at a lower end portion of the cover panel 2. The volume of the sound output through the speaker hole 17 is such a volume that can be heard even at a place distant from the mobile device 1.

The receiver 160 is, for example, formed of a dynamic speaker. The receiver 160 can, for example, convert the electrical sound signal from the controller 100 into sound to be output therefrom. The receiver 160 outputs received voice sound, for example. Sound output from the receiver 160 is, for example, output to the outside through the receiver hole 16 formed at an upper end portion of the cover panel 2. The volume of the sound output through the receiver hole 16 is, for example, smaller than the volume of the sound output from the speaker 170 through the speaker hole 17.

Note that, in place of the receiver 160, a piezoelectric vibration element may be provided. A piezoelectric vibration element can be vibrated based on the sound signal from the controller 100. The piezoelectric vibration element is, for example, provided on the back surface of the cover panel 2, and can thus vibrate the cover panel 2 through its own vibration based on the sound signal. Then, when the user brings his/her own ear closer to the cover panel 2, the vibration of the cover panel 2 is transmitted as voice to the user. Note that, if a piezoelectric vibration element is provided in place of the receiver 160, the receiver hole 16 is unnecessary.

The first camera 180 and the second camera 190 each include a lens, an image pickup element, and the like. The first camera 180 can be controlled by the controller 100. The first camera 180 can receive light at the image pickup element through the first-lens transparent member 18 and its lens to produce a captured image, and can output the captured image to the controller 100. The second camera 190 can be controlled by the controller 100. The second camera 190 can receive light at the image pickup element through the second-lens transparent member 19 and its lens to produce a captured image, and can output the captured image to the controller 100. Such captured images may be still images. Alternatively, the first camera 180 and the second camera 190 may produce a moving image by repeatedly (e.g., periodically) producing captured images.

The lens of the first camera 180 is visibly recognizable through the first-lens transparent member 18 provided on the back surface 1b of the mobile device 1. Accordingly, the first camera 180 can capture an image of an object present on the back surface 1b side with respect to the mobile device 1. Such a first camera 180 may be referred to as an “out-camera.” Further, the lens of the second camera 190 is visibly recognizable through the second-lens transparent member 19 provided on the cover panel 2. Accordingly, the second camera 190 can capture an image of an object present on the cover panel 2 side with respect to the mobile device 1, i.e., on the front surface 1a side with respect to the mobile device 1. Such a second camera 190 may be referred to as an “in-camera.”

The vibrator 200 can be, for example, vibrated based on an instruction of the controller 100. The vibration obtained from the vibrator 200 is transmitted to the outer package 4 of the mobile device 1. That is, the vibrator 200 can vibrate the outer package 4. Thus, for example, when the user is in contact with the outer package 4 of the mobile device 1, the vibration is transmitted to the user via the outer package 4. With this, the user can receive a notification from the mobile device 1. The vibrator 200 includes, for example, a vibrating motor (such as a DC motor or a linear motor) or a piezoelectric vibration element. Note that, for example, even when the user is out of contact with the outer package 4 of the mobile device 1, the user can receive a notification from the mobile device 1 through sound generated by the vibration of the mobile device 1.

The display 120, the speaker 170, and the vibrator 200 can output information to the user, and may be therefore regarded as an output unit 240 altogether. Further, the speaker 170 and the vibrator 200 can notify the user of occurrence of an event, and may be therefore regarded as a notification unit 250 altogether.

The solar panel 210 includes a plurality of photoelectric converters 211. Here, for example, each photoelectric converter 211 can be transparent and be located on or above the display panel 121 directly or with intermediation of another transparent layer. As such another transparent layer, for example, a layer including wiring for extracting an output from the solar panel 210, and a film-like layer that blocks light of an unnecessary wavelength emitted from the display panel 121 are applicable.

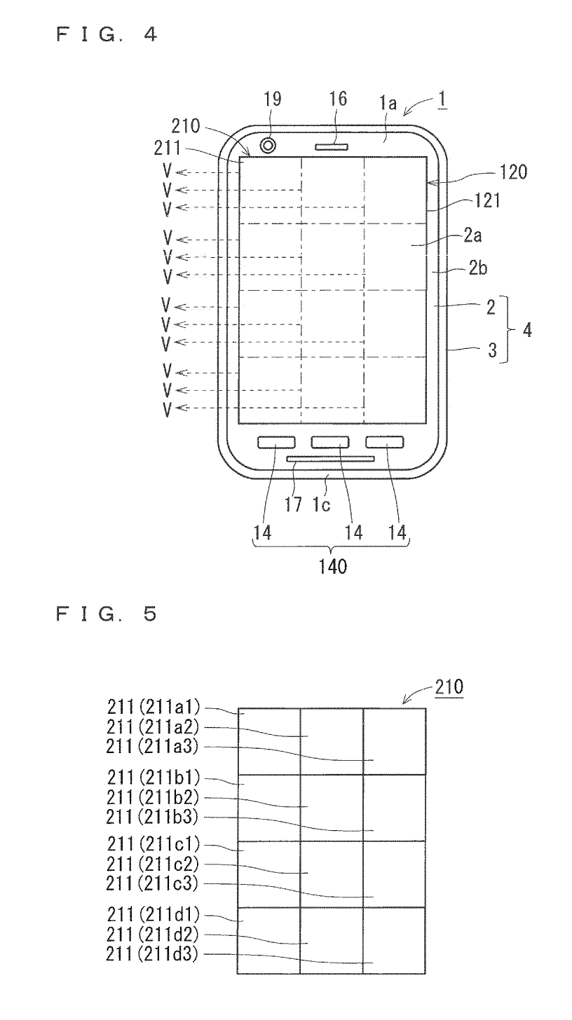

FIG. 4 is a diagram schematically illustrating one example of a manner of disposing the solar panel 210. FIG. 5 is a diagram schematically illustrating one example of a configuration of the solar panel 210. As illustrated in FIG. 4 and FIG. 5, the plurality of photoelectric converters 211 are adjacently located along the surface of the solar panel 210. Each photoelectric converter 211 has, for example, a rectangular shape in plan view, such that the plurality of photoelectric converters 211 are located so as to be arrayed in a matrix manner. In examples of FIG. 4 and FIG. 5, four columns of photoelectric converters 211, each column including three photoelectric converters 211 arrayed in horizontal direction, are arrayed in vertical direction. With this, a total of twelve photoelectric converters 211 located so as to be arrayed in a matrix manner makes up the solar panel 210.

In a specific example illustrated in FIG. 5, for example, assuming that the side of the receiver hole 16 is an upper side in plan view seen from a front side of the mobile device 1, four columns of photoelectric converters 211, each including three photoelectric converters 211 arrayed in horizontal direction, are arrayed from the upper side toward the lower side. More specifically, for example, photoelectric converters 211a1 to 211a3 are arrayed in order from left in a first row from the top of the solar panel 210, and photoelectric converters 211b1 to 211b3 are arrayed in order from left in a second row from the top. Further, for example, photoelectric converters 211c1 to 211c3 are arrayed in order from left in a third row from the top, and photoelectric converters 211d1 to 211d3 are arrayed in order from left in a fourth row from the top.

Further, each photoelectric converter 211 can generate power based on light that is incident on the photoelectric converter 211 through the front surface 1a being one surface of the outer package 4. In each photoelectric converter 211, a voltage V can be output through power generation. That is, in the solar panel 210, a voltage V is output at least per photoelectric converter 211. In one example of FIG. 4, the dashed arrow extending from each photoelectric converter 211 indicates that each photoelectric converter 211 outputs a voltage V.

Each photoelectric converter 211 includes, for example, a plate-like or film-like semiconductor portion in which a pair of semiconductor regions formed at least of a P-type semiconductor and an N-type semiconductor is stacked to be jointed together, and a pair of electrodes sandwiching the semiconductor portion. Then, when light is incident on the semiconductor portion, an electromotive force is generated at the region (also referred to as a PN junction region) where the P-type semiconductor region and the N-type semiconductor region are joined together, due to a photovoltaic effect.

Further, the pair of semiconductors is a transparent semiconductor that allows transmission of at least visible light, and has a bandgap of approximately 3 eV, for example. As such a semiconductor, for example, an oxide semiconductor such as a zinc oxide can be adopted. The voltage generated in the semiconductor is applied to the pair of electrodes. Here, it is only necessary that the pair of electrodes be transparent, and an indium tin oxide (ITO) film or the like can be adopted for each of the electrodes, for example. With this, the solar panel 210 can be a transparent panel that allows transmission of at least visible light.

Further, each photoelectric converter 211 can, for example, output the voltage V to be applied to the pair of electrodes. Note that, each photoelectric converter 211 may be formed of a single solar cell element (hereinafter also referred to as a cell), or may be formed of a plurality of cells arrayed to be mutually connected. If each photoelectric converter 211 is formed of a plurality of cells, for example, the plurality of cells may be connected in series or in parallel. Alternatively, a plurality of cells connected in series may be connected in parallel with another plurality of cells connected in series. If a plurality of cells are connected in series, a voltage V generated in the entire plurality of cells connected in series can be output by the mass of the cells. In this case, the voltage V output from each photoelectric converter 211 can be enhanced. Alternatively, if a plurality of cells are connected in parallel, a voltage V of each of the plurality of cells is output by each photoelectric converter 211, and therefore a current output from the photoelectric converters 211 can be increased. The voltage V generated by each photoelectric converter 211 is output to the power circuit 230 (see also FIG. 1).

The power circuit 230 can, for example, use the voltage obtained by connecting the plurality of photoelectric converters 211 in series or in parallel as a source voltage for the mobile device 1. Further, for example, in the power circuit 230, a voltage obtained by connecting in parallel the plurality of photoelectric converters 211 connected in series with another plurality of photoelectric converters 211 connected in series may be used as the source voltage. Then, the power circuit 230 can output the source voltage to the battery 220 to charge the battery 220, and can output the voltage to various components of the mobile device 1. Further, the power circuit 230 can also output electricity to various components from the battery 220. Note that, as the battery 220, for example, a rechargeable battery such as a lithium-ion secondary battery can be adopted.

Further, the power circuit 230 can output to the controller 100 a signal that corresponds to the magnitude of an output generated correspondingly to the amount of light incident on each photoelectric converter 211 (also referred to as a light incident amount). For example, the power circuit 230 detects a numerical value indicating the magnitude of the voltage V, current I, or electric power W that is output by each photoelectric converter 211 as a value (also referred to as a detected value) of a parameter corresponding to the light incident amount, and then outputs a signal related to the detected value to the controller 100. Specifically, for example, the power circuit 230 may detect a short circuit current that flows when a switch located between a pair of output terminals in the photoelectric converter 211 is turned on as a detected value corresponding to the light incident amount per photoelectric converter 211, and may then output a signal related to the detected value to the controller 100. The short circuit current is increased in accordance with increase in light amount. Therefore, the controller 100 can recognize the amount of light radiated to each photoelectric converter 211 based on the short circuit current.

Note that, the power circuit 230 need not necessarily include the configuration in which a signal corresponding to the amount of light incident on each photoelectric converter 211 is output to the controller 100. For example, a detector that detects the output of the photoelectric converter 211 may be provided, separately from the power circuit 230.

Further, connecting each photoelectric converter 211 and the power circuit 230 appropriately with a transparent wire, light emitted from the display panel 121 can be transmitted through the solar panel 210, the touch panel 130, and the cover panel 2. The transparent wire can be, for example, formed of a transparent flexible printed circuit board.

<(1-3) Configuration of Controller>

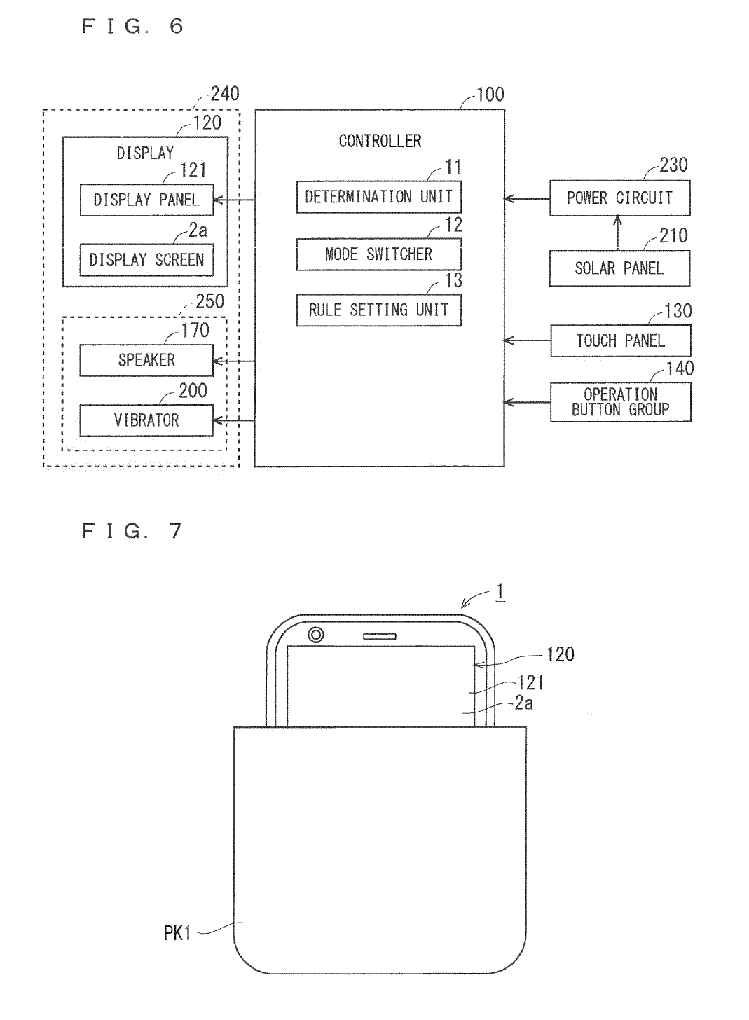

FIG. 6 is a functional block diagram illustrating one example of an internal configuration of the controller 100. Here, the controller 100 includes, for example, a determination unit 11, a mode switcher 12, and a rule setting unit 13, as its functional configuration implemented by executing the control program Pg1 stored in the storage medium 103.

<(1-3-1) Determination of Output>

The determination unit 11 can, for example, determine whether or not an output generated correspondingly to light received at each one of a preset number (also referred to as a predetermined number) of photoelectric converters 211 among the plurality of photoelectric converters 211 is a low output that meets criterion conditions. In the determination unit 11, for example, a signal related to a detected value indicating the magnitude of the output of each photoelectric converter 211 is acquired from the power circuit 230, and the detected value related to the output of each photoelectric converter 211 can thereby be recognized. Note that, in the determination unit 11, for example, an output generated correspondingly to received light is a high output that meets particular conditions is recognized for each photoelectric converter 211, and thereby the photoelectric converters 211 whose output generated correspondingly to received light is not a high output may be recognized.

Here, one is adopted as the predetermined number, for example, but two or more may be adopted as the predetermined number. The output generated correspondingly to light received at the photoelectric converter 211 may include, for example, at least one of the voltage V, the current I, and the electric power W that are output due to photoelectric conversion performed correspondingly to the light received by the photoelectric converter 211. The criterion conditions are conditions as a criterion for determining the high and low of an output. The criterion conditions include, for example, conditions that the numerical value indicating the magnitude of an output is less than a preset threshold value, and conditions that the reciprocal of the numerical value indicating the magnitude of an output is more than a preset threshold value. For example, when the voltage V output from the photoelectric converter 211 correspondingly to received light is less than a preset threshold value, the determination unit 11 can determine that the output generated correspondingly to the light received at the photoelectric converter 211 is a low output.

Further, as the numerical value indicating the magnitude of an output, for example, a detected value corresponding to the light incident amount input from the power circuit 230 can be adopted. As for the threshold value, for example, a single threshold value common to all of the plurality of photoelectric converters 211 may be set, a threshold value may be set per photoelectric converter 211, or a single threshold value common to two or more photoelectric converters 211 may be set.

Further, the high and low of the output generated correspondingly to the light received at the photoelectric converter 211 may differ, for example, due to a change in the amount of light incident on the photoelectric converter 211, depending on conditions where the user uses the mobile device 1.

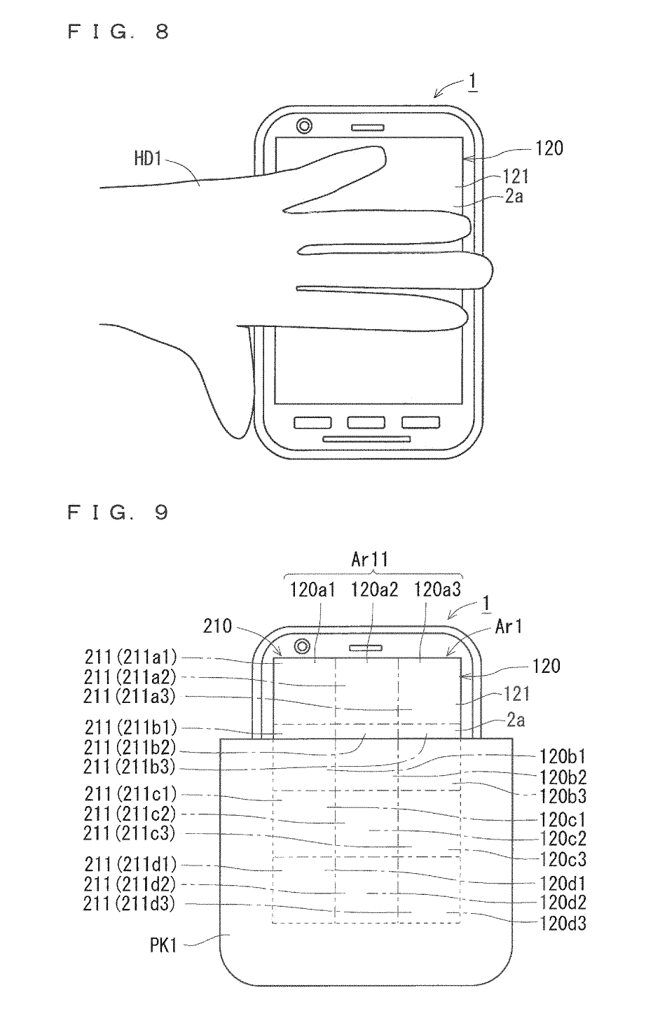

The conditions where the user uses the mobile device 1 may include, for example, a condition where the body of the user, clothes, items, etc. shield at least a part of the front surface 1a from light such that light from the outside of the mobile device 1 may not be incident on the front surface 1a. FIG. 7 illustrates one example of conditions where the user uses the mobile device 1. In one example of FIG. 7, the mobile device 1 is in a pocket PK1 of clothes, a bag, or the like. In this use condition, the presence of the pocket PK1 shields a part of the display screen 2a in the front surface 1a of the mobile device 1 from light such that outside light may not be incident on the display screen 2a. Further, FIG. 8 illustrates another example of conditions where the user uses the mobile device 1. In one example of FIG. 8, under a state where the mobile device 1 is placed with its front surface 1a facing up, a hand HD1 as a part of the body of the user is placed over the mobile device 1. In this use condition, the presence of the hand HD1 shields a part of the display screen 2a in the front surface 1a of the mobile device 1 from light such that outside light may not be incident on the display screen 2a. Such use conditions of the mobile device 1 can be, for example, changed by the user easily and intentionally.

Further, the amount of light incident on each photoelectric converter 211 can vary, for example, in accordance with distribution in the light incident amount of the light incident on the solar panel 210 where the plurality of photoelectric converters 211 are located. For example, depending on a condition where each of the plurality of photoelectric converters 211 is optically exposed, the amount of light incident on each photoelectric converter 211 varies.

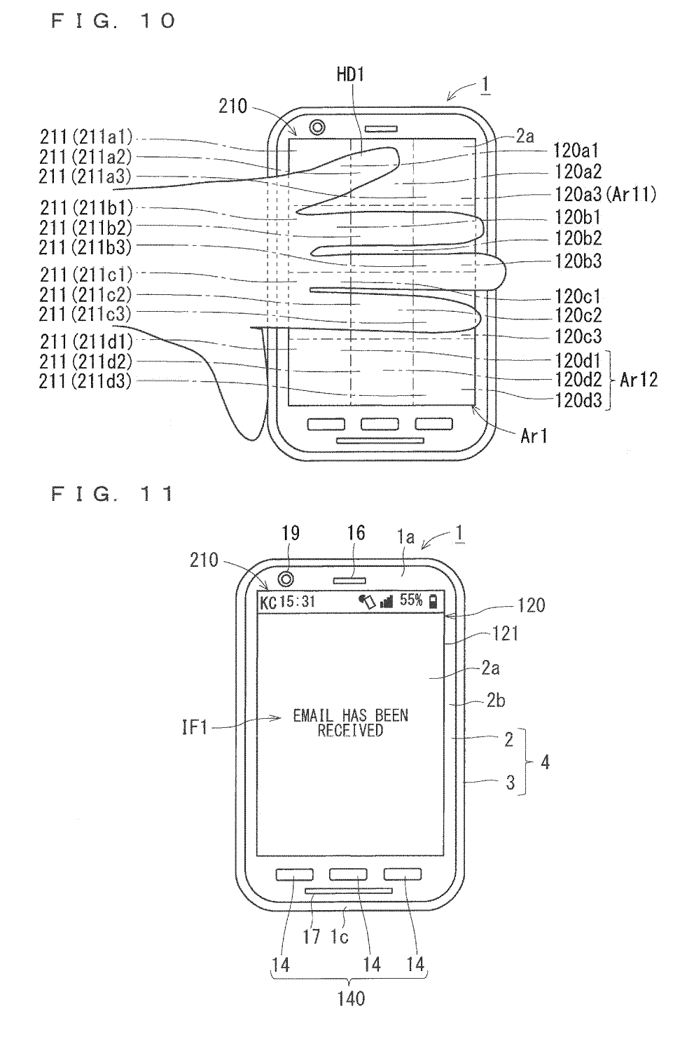

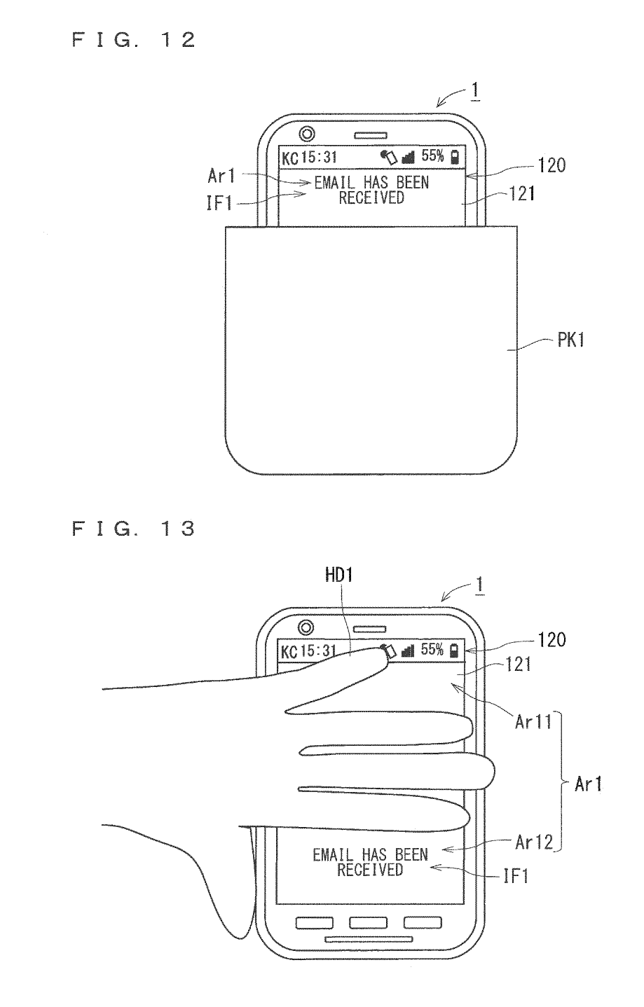

FIG. 9 illustrates one example of a condition where each photoelectric converter 211 is optically exposed, under one example of the use condition illustrated in FIG. 7 where the user uses the mobile device 1. In one example of FIG. 9, the three photoelectric converters 211a1 to 211a3 in the first row from the top, among the twelve photoelectric converters 211, are optically exposed. Meanwhile, most region of the three photoelectric converters 211b1 to 211b3 in the second row from the top and a total of the six photoelectric converters 211c1 to 211c3 and 211d1 to 211d3 respectively in the third and fourth rows from the top are not optically exposed but are shielded from light. In this case, for example, the determination unit 11 can determine that the output of the nine photoelectric converters 211b1 to 211b3, 211c1 to 211c3, and 211d1 to 211d3 respectively in the second to fourth rows from the top, among the plurality of photoelectric converters 211, is a low output.

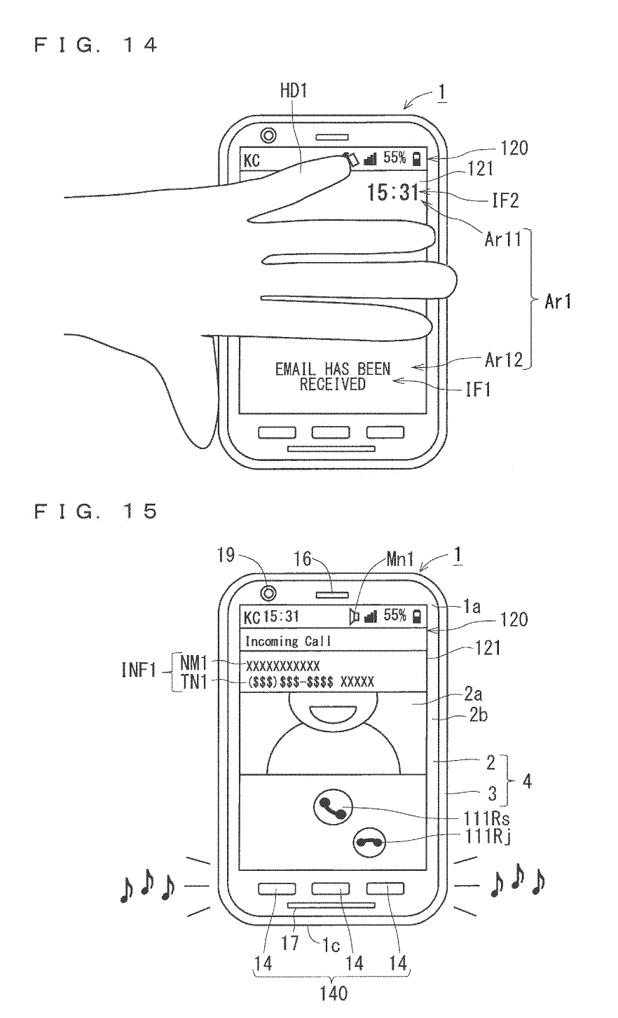

Further, FIG. 10 illustrates one example of a condition where each photoelectric converter 211 is optically exposed, under one example of the use condition illustrated in FIG. 8 where the user uses the mobile device 1. In one example of FIG. 10, the rightmost photoelectric converters 211a3 in the first row from the top and the three photoelectric converters 211d1 to 211d3 in the fourth row from the top, among the twelve photoelectric converters 211, are optically exposed. Meanwhile, at least a part of a region of each of two of the leftmost and the central photoelectric converters 211a1 and 211a2 in the first row from the top and a total of the six photoelectric converters 211b1 to 211b3 and 211c1 to 211c3 in the second and third rows from the top are not optically exposed but are shielded from light. In this case, for example, the determination unit 11 can determine that the output of the eight photoelectric converters 211a1, 211a2, 211b1 to 211b3, and 211c1 to 211c3, among the plurality of photoelectric converters 211, is a low output.

<(1-3-2) Switching Modes>

The mode switcher 12 can, for example, switch modes of operation (also referred to as operation modes) of the mobile device 1 in response to a fact that the output generated correspondingly to light received at each one of a preset number (predetermined number) of photoelectric converters 211 among the plurality of photoelectric converters 211 is a low output. In the mode switcher 12, for example, operation modes of the mobile device 1 are switched, depending on a determination result of the determination unit 11. That is, the controller 100 can, for example, switch operation modes of the mobile device 1 in response to a fact that the output generated correspondingly to light received at each one of a predetermined number of photoelectric converters 211 among the plurality of photoelectric converters 211 is a low output. That is, the controller 100 can control switching of the operation modes.

In this manner, for example, adopting the configuration in which the operation modes of the mobile device 1 can be switched depending on the conditions where the user uses the mobile device 1, the function of the mobile device 1 installed with the solar panel 210 as a solar cell can be improved.

Incidentally, if an operation mode to be switched to includes, for example, a mode (also referred to as an output mode) in which the output unit 240 outputs information, for example, an output mode depending on the conditions where the user uses the mobile device 1 can be realized. Note that, an operation mode to be switched to may include, for example, another operation mode such as a mode (also referred to as processing mode) in which the controller 100 processes information. In this case, for example, a processing mode depending on the conditions where the user uses the mobile device 1 can be realized.

Here, for example, if the output mode includes a mode (also referred to as a display mode) in which the display 120 visibly outputs information, for example, a display mode depending on the conditions where the user uses the mobile device 1 can be realized. With this, for example, the function of the mobile device 1 concerning switching of modes of display can be enhanced.

Further, for example, if the output mode includes a mode (also referred to as a notification mode) in which the notification unit 250 notifies of occurrence of an event, for example, a notification mode depending on the conditions where the user uses the mobile device 1 can be realized. With this, for example, the function of the mobile device 1 concerning switching of modes of notification can be enhanced.

<(1-3-2-1) Switching of Display Modes>

As a specific example of switching of display modes, one example is conceivable: display modes are switched by the controller 100 such that at least a specific type of information may be displayed in a region (also referred to as a target display region) in the display 120 other than a region where one or more photoelectric converters 211 whose output is a low output among the plurality of photoelectric converters 211 are stacked. Here, a predetermined number of photoelectric converters 211 whose output is a low output as necessary for switching the display modes suffices to be one.

Here, the specific type of information can be, for example, specified by data stored in the storage medium 103, such as the control program Pg1. Further, the specific type of information may include, for example, information important to the user, such as information indicating reception of a call and email as contact made by others. Note that, the specific type of information may include, for example, information concerning occurrence of various important events, such as information about schedules and updates of applications. In this case, important information can be displayed in a part of the display screen 2a not shielded by the body of the user, clothes, items, etc. That is, a display mode depending on the user's use condition can be realized.

The target display region may be, for example, a region in the display 120 where one or more photoelectric converters 211 whose output is a high output that meets particular conditions, among the plurality of photoelectric converters 211, are stacked. The particular conditions are conditions used when the high and low of an output is determined. The particular conditions include, for example, conditions that the numerical value indicating the magnitude of an output is equal to or more than a preset threshold value, and conditions that the reciprocal of the numerical value indicating the magnitude of an output is equal to or less than a preset threshold value. For example, when the voltage V output from the photoelectric converter 211 correspondingly to received light is equal to or more than a preset threshold value, the determination unit 11 can determine that the output generated correspondingly to the light received at the photoelectric converter 211 is a high output. Even with such a configuration, important information can be displayed in a part of the display screen 2a not shielded by the body of the user, clothes, items, etc., as long as the specific type of information is information important to the user, for example. That is, a display mode depending on the user's use condition can be realized.

In one example of this embodiment, as illustrated in FIG. 9 and FIG. 10, for example, the display 120 includes twelve regions (also referred to as displayable regions) 120a1 to 120a3, 120b1 to 120b3, 120c1 to 120c3, and 120d1 to 120d3 where the twelve photoelectric converters 211a1 to 211a3, 211b1 to 211b3, 211c1 to 211c3, and 211d1 to 211d3 are respectively stacked.

Here, FIG. 11 illustrates one example of a display mode of information in the mobile device 1 under the use condition where the entire display 120 is not covered as illustrated in FIG. 1. In one example of FIG. 11, a specific type of information IF1 is displayed substantially at the center of the display screen 2a.

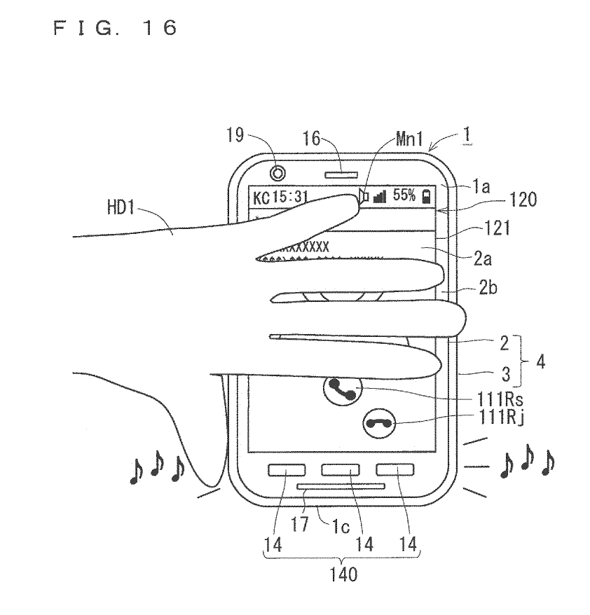

Meanwhile, FIG. 12 illustrates one example of a display mode of information in the mobile device 1 under the use condition illustrated in FIG. 7. In one example of FIG. 12, as illustrated in FIG. 9, the specific type of information IF1 is displayed in a target display region Ar1 made up of the displayable regions 120a1 to 120a3 other than the displayable regions 120b1 to 120b3, 120c1 to 120c3, and 120d1 to 120d3 where the nine photoelectric converters 211b1 to 211b3, 211c1 to 211c3, and 211d1 to 211d3 whose output is a low output among the plurality of photoelectric converters 211 are respectively stacked. In other words, in the display 120, the specific type of information IF1 is displayed in the target display region Ar1 made up of the three displayable regions 120a1 to 120a3 where the three photoelectric converters 211a1 to 211a3 whose output is a high output among the plurality of photoelectric converters 211 are stacked. In one example of FIG. 12, the specific type of information IF1 is a piece of information important to the user, such as one indicating that email has been received.

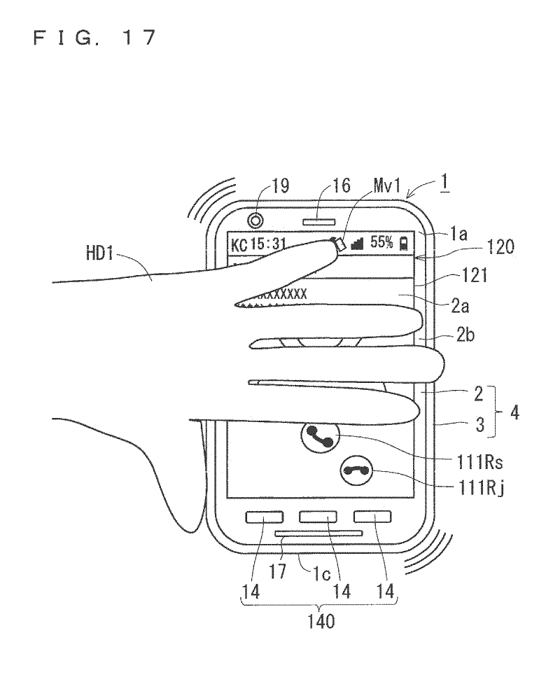

FIG. 13 illustrates one example of a display mode of information in the mobile device 1 under the use condition illustrated in FIG. 8. In one example of FIG. 13, as illustrated in FIG. 10, the specific type of information IF1 is displayed in the target display region Ar1 made up of four displayable regions 120a3 and 120d1 to 120d3 other than the displayable regions 120a1, 120a2, 120b1 to 120b3, and 120c1 to 120c3 where the eight photoelectric converters 211a1, 211a2, 211b1 to 211b3, and 211c1 to 211c3 whose output is a low output among the plurality of photoelectric converters 211 are respectively stacked. In other words, in the display 120, the specific type of information IF1 is displayed in the target display region Ar1 made up of the four displayable regions 120a3 and 120d1 to 120d3 where the four photoelectric converters 211a3 and 211d1 to 211d3 whose output is a high output among the plurality of photoelectric converters 211 are stacked. In one example of FIG. 13, the specific type of information IF1 is a piece of information important to the user, such as one indicating that email has been received.

Further, for example, if the target display region Ar1 includes two or more regions that are separated away from one another, the controller 100 may perform control such that at least a specific type of information may be displayed in a region of the largest size among the two or more regions.

For example, one case is assumed: under the use condition illustrated in FIG. 8 where the user uses the mobile device 1, as illustrated in FIG. 10, the output generated correspondingly to light received at each one of the rightmost photoelectric converter 211a3 in the first row from the top and the three photoelectric converters 211d1 to 211d3 in the fourth row from the top, among the twelve photoelectric converters 211, is a high output. In this case, as illustrated in FIG. 13, the target display region Ar1 in the display 120 includes a first target display region Ar11 and a second target display region Ar12. The first target display region Ar11 is a unit region made up of one displayable region 120a3 where one photoelectric converter 211a3 is stacked. Further, the second target display region Ar12 is a unit region that is separated away from the first target display region Ar11 and is made up of three displayable regions 120d1 to 120d3 where three photoelectric converters 211d1 to 211d3 are respectively stacked. Further, the second target display region Ar12 has an area three times as large as that of the first target display region Ar11. In this case, as illustrated in FIG. 13, the controller 100 can perform control such that the specific type of information IF1 may be displayed in the second target display region Ar12 of the largest size, among the first target display region Ar11 and the second target display region Ar12 that are separated away from each other in the target display region Ar1.

Further, for example, if the target display region Ar1 includes two or more regions that are separated away from one another, a specific type of information may be displayed in a region of the largest size among the two or more regions, and another type of information that is different from the specific type of information may be displayed in a region of a relatively small size among the two or more regions. Such another type of information can be, for example, specified by data stored in the storage medium 103, such as the control program Pg1. The specific type of information and another type of information different from the specific type of information that are displayed in the target display region Ar1 may be set by the user. Further, another type of information may include, for example, information that could not be fully displayed in the region of the largest size in the target display region Ar1, important information such as time having an amount of information displayable even in a region of a limited size, etc. In this case, information important to the user in a certain degree can be displayed in a part of the display screen 2a not shielded by the body of the user, clothes, items, etc. With this, a display mode depending on the user's use condition can be realized.

The controller 100 may change at least one of the size of information (e.g., the size of letters and the size of figures) and the display mode, such that the information ought to be displayed in the target display region Ar1 may be displayed within the target display region Ar1. For example, when the size of the target display region Ar1 is relatively small, the size of the letters of “Email has been received” may be reduced so as to be displayed, or an icon indicating email may be displayed in place of the display of the letters of “Email has been received.”

In this case, for example, FIG. 14 illustrates one example of a display mode of information in the mobile device 1 under the use condition illustrated in FIG. 8. Here, for example, the target display region Ar1 includes the first target display region Ar11 and the second target display region Ar12 that serve as two or more unit regions separated away from one another. Further, the specific type of information IF1 is displayed in the second target display region Ar12 of the largest size among the first target display region Ar11 and the second target display region Ar12, and another type of information IF2 is displayed in the first target display region Ar11 that is smaller than the second target display region Ar12. In one example of FIG. 14, the specific type of information IF1 is a piece of information important to the user such as one indicating that email has been received, and another type of information IF2 is another piece of information important to the user such as time.

<(1-3-2-2) Switching of Notification Modes>

It is conceivable that events to be notified of may include incoming. The incoming may include, for example, incoming of a voice call and email, and incoming of a massage of a social networking service etc. In this case, for example, one example is conceivable: notification modes of notifying of incoming in the mobile device 1 are switched by the controller 100 in response to a fact that the output generated correspondingly to light received at each one of a preset number (predetermined number) of photoelectric converters 211 among the plurality of photoelectric converters 211 is a low output.

Here, the predetermined number can be, for example, set to be any number equal to or more than 1. For example, the predetermined number can be set on the basis of various viewpoints; a viewpoint such that user's unintended switching of notification modes is hardly caused, and a viewpoint such that the user can easily execute switching of notification modes. Specifically, in consideration of operation or the like of the user performed on an incoming screen to be displayed in the display 120 during incoming, for example, the predetermined number can be set to be an appropriate number such as 3. Note that, the predetermined number can be, for example, appropriately set by specification made by data stored in the storage medium 103, such as the control program Pg1, and by various instructions issued to the mobile device 1 by the user via the touch panel 130, the operation button group 140, or the microphone 150.

As a specific example in which the notification modes of notifying of incoming are switched by the controller 100, one example is given: a notification mode of notifying of occurrence of incoming with sound output from the speaker 170 is switched to a notification mode of notifying of occurrence of incoming with vibration of the outer package 4 as obtained from the vibrator 200. In other words, for example, one example is conceivable in which modes are switched from a notification mode (also referred to as a normal mode) of notifying of occurrence of incoming with sound such as a melody to a notification mode (also referred to as a vibration mode) of notifying of occurrence of incoming with vibration of the outer package 4.

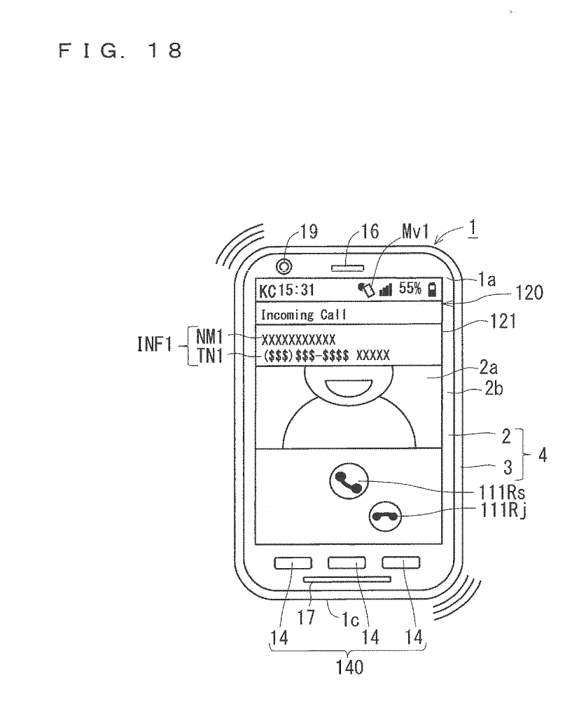

FIG. 15 to FIG. 17 illustrate one example of a state in which the notification modes are switched from the normal mode to the vibration mode in response to a fact that the output generated correspondingly to light received at each one of a predetermined number of photoelectric converters 211 among the plurality of photoelectric converters 211 is a low output.

FIG. 15 illustrates a state of the mobile device 1 in which an incoming screen is displayed in the display 120 and occurrence of incoming is being notified of by sound output from the speaker 170 or the like, in response to occurrence of the incoming. That is, FIG. 15 illustrates a state of the mobile device 1 during incoming in the normal mode.

In the incoming screen, information INF1 of a calling partner is displayed. The information INF1 of a calling partner suffices to be information that allows to specify the calling partner, and is a call identification number (e.g., a telephone number) allocated to each mobile device, for example. In one example of FIG. 15, the identification number of the calling partner is indicated by symbols TN1. The identification number is contained in an incoming signal. The controller 100 recognizes the identification number of the calling partner based on the incoming signal, and can display the identification number on the display 120.

Further, in the incoming screen, a name may be displayed as the information INF1 of the calling partner. For example, provided that the storage medium 103 stores information of a phonebook, the phonebook information contains a plurality of identification numbers as well as user names that correspond to the respective identification numbers. Therefore, the controller 100 can recognize the identification number contained in the incoming signal, and can specify the name of the calling partner based on the identification number and the phonebook information. Then, the name of the calling partner can be displayed on the display 120. In one example of FIG. 15, the name of the calling partner is indicated by symbols NM1.

Further, in the incoming screen illustrated in FIG. 15, an element 111Rs that functions as an answer button for the incoming, and an element 111Rj that functions as a reject button are displayed. In the incoming screen, when the user performs operation on the element 111Rs or the element 111Rj, the operation is detected by the touch panel 130 to be output to the controller 100. As such an operation, for example, an operation (what is called a tap operation), in which a pointer is brought closer to the element and is then brought away from the element, can be adopted. Being brought closer herein includes, for example, a state of being brought near to the display screen 2a as well as a state of being brought in contact with the display screen 2a. The controller 100 can start a call in accordance with the operation performed on the element 111Rs, or can cut off communication with the calling partner in accordance with the operation performed on the element 111Rj. Note that, the operation on the element 111Rs may include a flick operation performed by the user. A flick operation refers to an operation in which the user flicks the display screen 2a with a pointer such as a finger or a pen.

Note that, a status bar is appropriately displayed, for example, at an upper end portion of various screens such as an incoming screen displayed in the display screen 2a. A status bar is, for example, a display region where icons or the like that indicates the current state of the mobile device 1 can be displayed. In one example of FIG. 15, an icon Mn1 that indicates that the mode is set to be the normal mode is displayed.

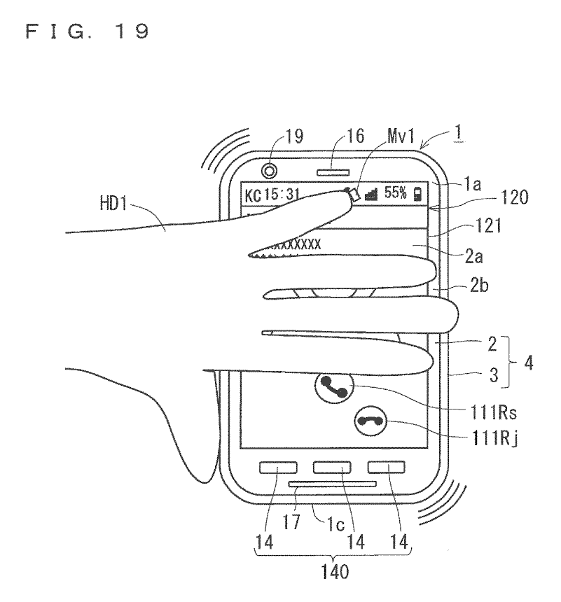

FIG. 16 illustrates a state of the mobile device 1 in which at least a part of the display 120 is covered by a hand of the user while sound for notifying of occurrence of incoming is output from the speaker 170 or the like. Note that, for example, at least a part of the display 120 may be covered by various objects such as a document, stationary, and clothes, in place of a hand. As illustrated in FIG. 16, when at least a part of the display 120 is covered by a hand, as illustrated in FIG. 10, among the twelve photoelectric converters 211, each output of the four photoelectric converters 211a3 and 211d1 to 211d3 becomes a high output, whereas each output of the eight photoelectric converters 221a1, 211a2, 211b1 to 211b3, and 211c1 to 211c3 becomes a low output. In this case, the output generated correspondingly to light received at each one of a predetermined number of (e.g., three) photoelectric converters 211 among the plurality of photoelectric converters 211 becomes a low output. Then, in response to such a state, for example, the notification mode of notifying of incoming in the mobile device 1 is switched by the controller 100 from the normal mode to the vibration mode.

FIG. 17 illustrates a state in which the notification mode of the mobile device 1 is switched to the vibration mode and occurrence of incoming is being notified of by vibration of the outer package 4 as obtained from the vibrator 200. In this case, in the incoming screen illustrated in FIG. 17, for example, an icon Mv1 that indicates that the mode is set to be the vibration mode is displayed in the status bar and the like.

As illustrated in FIG. 15 to FIG. 17, in the mobile device 1, when a region of the display 120 of a certain size is covered by a hand of the user while sound for notifying of occurrence of incoming is output from the speaker 170 or the like, the notification mode of notifying of incoming can be switched from the normal mode to the vibration mode. Therefore, for example, when a hand of the user or the like is placed on the display screen 2a of the mobile device 1 during a ringtone being generated from the mobile device 1 in response to occurrence of the incoming under a state in which the mobile device 1 is placed on a desk or the like with the display 120 facing up, the notification mode of notifying of incoming can be switched from the normal mode to the vibration mode. With this, making use of the function of the solar panel 210, switching of modes of notification in the mobile device 1 can be realized easily. That is, the function of the mobile device 1 concerning switching of modes of notification can be enhanced.

Further, as a specific example in which the notification modes of notifying of incoming are switched by the controller 100, one example is given: for example, a notification mode of notifying of occurrence of incoming with vibration of the outer package 4 as obtained from the vibrator 200 is switched to a notification mode of notifying of occurrence of incoming with neither of sound nor vibration of the outer package 4. That is, for example, one example is conceivable in which modes are switched from the vibration mode of notifying of occurrence of incoming with vibration of the outer package 4 to a notification mode (also referred to as a silent mode) of visibly notifying of occurrence of incoming via the display 120 or the like without the use of sound or vibration.

FIG. 18 to FIG. 20 illustrate one example of a state in which the notification modes are switched from the vibration mode to the silent mode in response to a fact that the output generated correspondingly to light received at each one of a predetermined number of photoelectric converters 211 among the plurality of photoelectric converters 211 is a low output.

FIG. 18 illustrates a state of the mobile device 1 in which an incoming screen is displayed in the display 120 and occurrence of incoming is being notified of by vibration of the outer package 4 as obtained from the vibrator 200, in response to occurrence of the incoming. That is, FIG. 18 illustrates a state of the mobile device 1 during incoming in the vibration mode.

FIG. 19 illustrates a state of the mobile device 1 in which at least a part of the display 120 is covered by a hand of the user or the like while occurrence of incoming is notified of by vibration of the outer package 4 as obtained from the vibrator 200. As illustrated in FIG. 19, when at least a part of the display 120 is covered by a hand, as illustrated in FIG. 10, the output generated correspondingly to light received at each one of a predetermined number of (e.g., three) photoelectric converters 211 among the plurality of photoelectric converters 211 becomes a low output. Then, in response to such a state, for example, the notification mode of notifying of incoming in the mobile device 1 is switched by the controller 100 from the vibration mode to the silent mode.

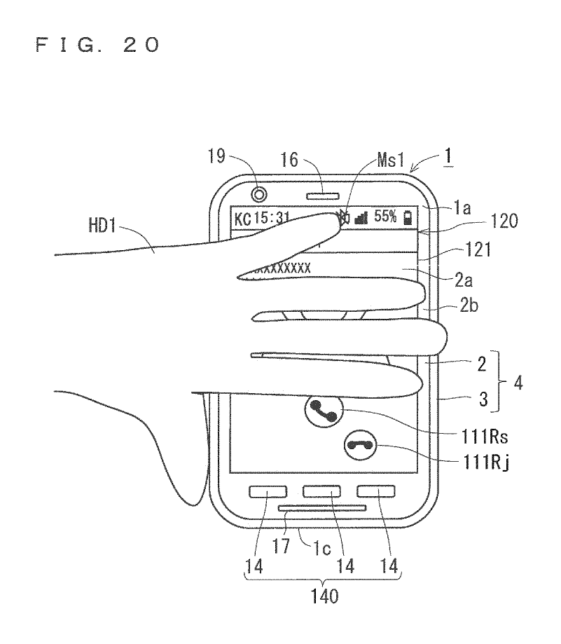

FIG. 20 illustrates a state in which the notification mode of the mobile device 1 is set to be the silent mode of notifying of occurrence of incoming with neither of sound nor vibration. In one example of FIG. 20, the user is visibly notified of occurrence of incoming by display of an incoming screen on the display screen 2a. In the incoming screen illustrated in FIG. 20, for example, an icon Ms1 that indicates that the mode is set to be the silent mode is displayed in the status bar and the like. Note that, for example, if the notification mode of the mobile device 1 is set to be the silent mode, the occurrence of incoming may be notified of by blinking of a light emitting unit (not shown). The light emitting unit can be, for example, formed of a light emitting diode (LED) or the like.

As illustrated from FIG. 18 to FIG. 20, in the mobile device 1, when a region of the display 120 of a certain size is covered by a hand of the user while occurrence of incoming is notified of by vibration of the outer package 4 as obtained from the vibrator 200, the notification mode of notifying of incoming can be switched from the vibration mode to the silent mode. Therefore, for example, when a hand of the user or the like is placed on the display screen 2a of the mobile device 1 during vibration being generated from the mobile device 1 in response to occurrence of the incoming under a state in which the mobile device 1 is placed on a desk or the like with the display 120 facing up, the notification mode of notifying of incoming can be switched from the vibration mode to the silent mode. Also in such a manner, making use of the function of the solar panel 210, switching of modes of notification in the mobile device 1 can be realized easily. That is, the function of the mobile device 1 concerning switching of modes of notification can be enhanced.

Further, as a specific example in which the notification modes of notifying of incoming are switched by the controller 100, one example is given: for example, a notification mode of notifying of occurrence of incoming with sound output from the speaker 170 is switched to a notification mode of notifying of occurrence of incoming with neither of sound nor vibration of the outer package 4. That is, for example, one example is conceivable in which modes are switched from the normal mode of notifying of occurrence of incoming with sound such as a melody to the silent mode of visibly notifying of occurrence of incoming via the display 120 or the like without the use of sound or vibration.

FIG. 15, FIG. 16, and FIG. 20 illustrate one example of a state in which the notification modes are switched from the normal mode to the silent mode in response to a fact that the output generated correspondingly to light received at each one of a predetermined number of photoelectric converters 211 among the plurality of photoelectric converters 211 is a low output.

Here, as illustrated in FIG. 15, FIG. 16, and FIG. 20, in the mobile device 1, when a region of the display 120 of a certain size is covered by a hand of the user while sound for notifying of occurrence of incoming is output from the speaker 170 or the like, the notification mode of notifying of incoming can be switched from the normal mode to the silent mode. Therefore, for example, when a hand of the user or the like is placed on the display screen 2a of the mobile device 1 during a ringtone being generated from the mobile device 1 in response to occurrence of the incoming under a state in which the mobile device 1 is placed on a desk or the like with the display 120 facing up, the notification mode of notifying of incoming can be switched from the normal mode to the silent mode. Also in such a manner, making use of the function of the solar panel 210, switching of modes of notification in the mobile device 1 can be realized easily. That is, the function of the mobile device 1 concerning switching of modes of notification can be enhanced.

Note that, for example, under a state in which the notification mode is set to be the normal mode by control of the controller 100, the notification mode may be switched from the normal mode to either of the vibration mode or the silent mode, depending on a degree in which the display 120 is covered by a hand or the like. In this case, for example, the following manner is conceivable: modes are switched from the normal mode to the vibration mode by the controller 100 on the condition that each output of a first number or more and less than a second number of photoelectric converters 211 among the twelve photoelectric converters 211 is a low output, and modes are further switched to the silent mode by the controller 100 on the condition that each output of the second number or more and a third number or less of photoelectric converters 211 among the twelve photoelectric converters 211 is a low output. Here, for example, the following manner is conceivable in which the first number is set to be a natural number such as from 3 to 5, the second number is set to be a natural number larger than the first number such as from 6 to 9, and the third number is set to be a natural number larger than the second number such as from 9 to 12.

Further, for example, the following manner is also conceivable: when the display 120 is covered by a hand or the like under a state in which a mode is set to be the normal mode by the control of the controller 100, the notification modes are switched such that the volume of a melody for notifying of incoming is reduced. For example, the notification modes may be able to be switched by control of the controller 100 among a notification mode (also referred to as a large volume mode) in which the volume of a melody is large, a notification mode (also referred to as an intermediate volume mode) in which the volume of a melody is intermediate, and a notification mode (also referred to as a small volume mode) in which the volume of a melody is small.

Incidentally, for example, when the number of photoelectric converters 211 among the plurality of photoelectric converters 211 whose output generated correspondingly to received light is a low output is changed to be less than a predetermined number after the notification modes once have been switched by control of the controller 100, the notification modes may be switched back to a previous mode before the switching. With this, for example, the user can easily switch the notification modes by removing a hand or the like from the upper area of the display screen 2a of the mobile device 1.

<(1-3-3) Setting of Switching Rule for Modes>

The rule setting unit 13 can set a rule (also referred to as a switching rule) in which operation modes are switched by the mode switcher 12. Here, in the switching rule, for example, a first mode before switching of modes, a second mode that is different from the first mode after the switching of modes, and conditions on which modes are switched from the first mode to the second mode are specified.

In the rule setting unit 13, for example, the switching rule can be set by data stored in the storage medium 103, such as the control program Pg1, and by various instructions issued to the mobile device 1 by the user via the touch panel 130, the operation button group 140, the microphone 150, or the like.

Further, in the rule setting unit 13, for example, the switching rule may be changed depending on a use condition of the mobile device 1. The use condition of the mobile device 1 may herein include, for example, orientation of the mobile device 1, a moving condition of the mobile device 1, a setting of brightness of the display screen 2a and the like. The orientation and moving condition of the mobile device 1 can be detected by an acceleration sensor or the like installed in the mobile device 1. The setting of brightness of the display screen 2a can be, for example, appropriately set by various instructions issued to the mobile device 1 by the user via the touch panel 130, the operation button group 140, the microphone 150, or the like.

Further, for example, the rule setting unit 13 may be configured not to perform operation of switching modes if the use condition of the mobile device 1 in which each output of all of the photoelectric converters 211 in the mobile device 1 is a low output continues for a preset period of time or more. The state in which each output of all of the photoelectric converters 211 is a low output may be caused by, for example, a state in which the mobile device 1 is used in a dark place, a state in which the mobile device 1 is placed inside a bag, a pocket, or the like, and a state in which the mobile device 1 is placed on a desk or the like with the display screen 2a facing down.

Note that, for example, in a configuration in which the switching rule is determined by the control program Pg1 or the like and is not changed, the rule setting unit 13 may be omitted.

<(1-4) Specific Example of Operation Flow Concerning Switching of Operation Modes>

Here, description will be given of a method for controlling the mobile device 1, in which processing (also referred to as switching processing) of switching operation modes of the mobile device 1 is controlled. Here, as specific examples, description will be given in order of an operation flow concerning switching processing to be executed regardless of the presence or absence of occurrence of an event such as incoming, and an operation flow concerning switching processing that can be executed due to occurrence of an event such as incoming.

<(1-4-1) Switching Processing to be Executed Regardless of Presence or Absence of Occurrence of Event>

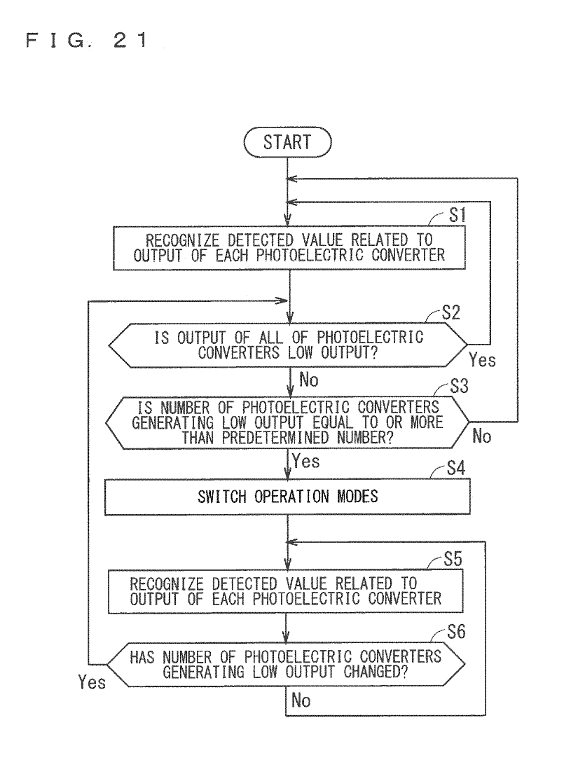

FIG. 21 is a flowchart illustrating one example of an operation flow concerning switching processing to be executed regardless of the presence or absence of occurrence of an event in the mobile device 1. Modes to be switched regardless of the presence or absence of occurrence of an event may include, for example, a display mode and various processing modes.

The operation flow illustrated in FIG. 21 can be, for example, implemented by various functions of the controller 100 that control switching of operation modes. Such various functions can be, for example, implemented by executing the control program Pg1 in the controller 100. In other words, the control operation illustrated in FIG. 21 can be, for example, implemented by executing the control program Pg1 in the controller 100.

In Step S1 of FIG. 21, the determination unit 11 recognizes a detected value related to the output of each photoelectric converter 211. Here, the detected value can be, for example, recognized based on a signal input from the power circuit 230.

In Step S2, the determination unit 11 determines whether or not each output of all of the photoelectric converters 211 that make up the solar panel 210 is a low output. Here, if each output of all of the photoelectric converters 211 is a low output, the process returns to Step S1. With this, inconvenience in which the display screen 2a displays no information during the use of the mobile device 1 in a dark place or the like can be avoided. Conversely, if each output of one or more of photoelectric converters 211 is not a low output, the process proceeds to Step S3.

In Step S3, the determination unit 11 determines whether or not the output generated correspondingly to light received at each one of a preset number (predetermined number) of photoelectric converters 211 among the adjacently located plurality of photoelectric converters 211 is a low output that meets criterion conditions. Here, if the number of the photoelectric converters 211 each generating a low output is not equal to or more than the predetermined number, the process returns to Step S1. Conversely, if the number of the photoelectric converters 211 each generating a low output is equal to or more than the predetermined number, the process proceeds to Step S4. If the operation mode to be switched to is a display mode, for example, the predetermined number suffices to be one.

In Step S4, the mode switcher 12 switches the operation modes of the mobile device 1. That is, in response to the determination made that each output of the preset number (predetermined number) of photoelectric converters 211 is a low output, the operation modes of the mobile device 1 are switched. Here, for example, the specific type of information IF1 displayed substantially at the center of the display screen 2a as illustrated in FIG. 11 is displayed in a region of the display screen 2a not shielded by a hand of the user or the like as illustrated in FIG. 12 to FIG. 14. With this, for example, a display mode depending on the user's use condition can be realized.

In Step S5, similarly to the above Step S1, the determination unit 11 recognizes a detected value related to the output of each photoelectric converter 211.

In Step S6, the determination unit 11 determines whether or not the number of the photoelectric converters 211 each generating a low output has changed. Here, for example, if the number of the photoelectric converters 211 each generating a low output has not changed, the process of Steps S5 and S6 are repeated until the number of the photoelectric converters 211 each generating a low output changes. Conversely, if the number of the photoelectric converters 211 each generating a low output has changed, the process returns to Step S2. Note that, the detected value per photoelectric converter 211 that is recognized based on a signal input from the power circuit 230 is, for example, stored in the storage medium 103. Then, when the detected value per photoelectric converter 211 is changed, data indicating the detected value per photoelectric converter 211 that is stored in the storage medium 103 is changed.

For example, such an operation flow may be repeatedly performed if the power of the mobile device 1 is on, and may be forcibly ended if the power of the mobile device 1 is off.

<(1-4-2) Switching Processing to be Executed Due to Occurrence of Event>

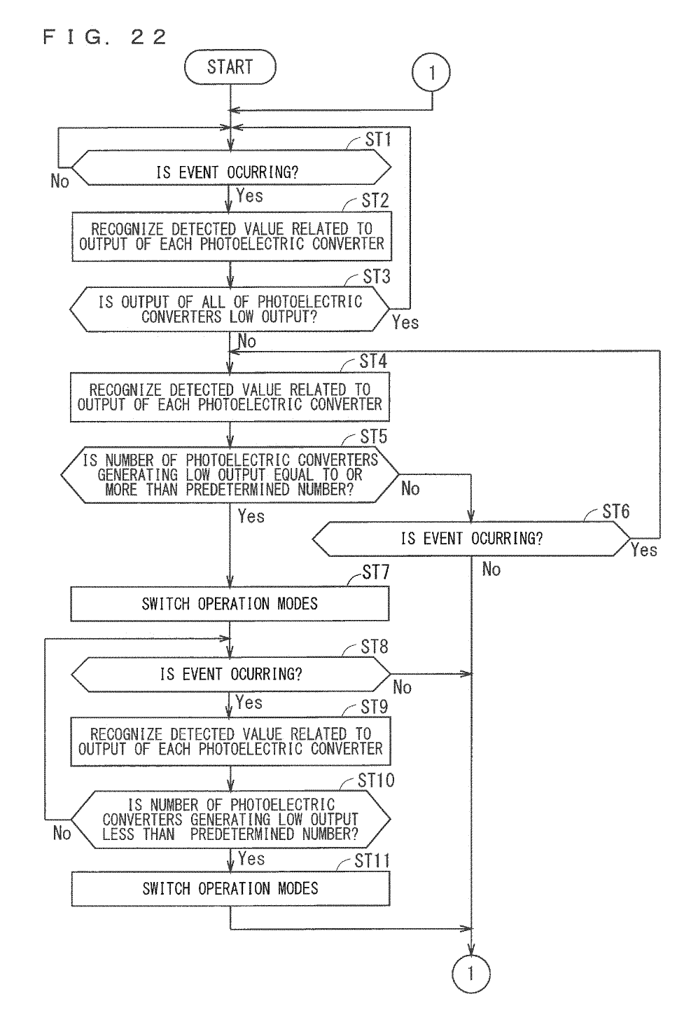

FIG. 22 is a flowchart illustrating one example of an operation flow concerning switching processing to be executed during occurrence of an event such as incoming in the mobile device 1. Modes to be switched during occurrence of an event may include, for example, a notification mode.

The operation flow illustrated in FIG. 22 can be, for example, implemented by various functions of the controller 100 that control switching of operation modes. Such various functions can be, for example, implemented by executing the control program Pg1 in the controller 100. In other words, the control operation illustrated in FIG. 22 can be, for example, implemented by executing the control program Pg1 in the controller 100.

In Step ST1 of FIG. 22, the controller 100 determines whether or not an event is occurring. The event may include, for example, incoming in communication and the like of voice and email with another external mobile device and the like. Here, the process of Step ST1 is repeated until an event occurs, and the process proceeds to Step ST2 if an event occurs.

In Step ST2, similarly to the Step S1 of FIG. 21, the determination unit 11 recognizes a detected value related to the output of each photoelectric converter 211.

In Step ST3, similarly to Step S2 of FIG. 21, the determination unit 11 determines whether or not each output of all of the photoelectric converters 211 that make up the solar panel 210 is a low output. Here, if each output of all of the photoelectric converters 211 is a low output, the process returns to Step ST1. Conversely, if each output of one or more of photoelectric converters 211 is not a low output, the process proceeds to Step ST4.

In Step ST4, similarly to the above Step ST2, the determination unit 11 recognizes a detected value related to the output of each photoelectric converter 211.

In Step ST5, similarly to Step S3 of FIG. 21, the determination unit 11 determines whether or not the output generated correspondingly to light received at each one of a preset number (predetermined number) of photoelectric converters 211 among the adjacently located plurality of photoelectric converters 211 is a low output that meets criterion conditions. Here, if the number of the photoelectric converters 211 each generating a low output is not equal to or more than the predetermined number, the process proceeds to Step ST6. Conversely, if the number of the photoelectric converters 211 each generating a low output is equal to or more than the predetermined number, the process proceeds to Step ST7.

In Step ST6, similarly to the above Step ST1, the controller 100 determines whether or not an event is occurring. Here, the process returns to Step ST4 if an event is occurring, and the process returns to Step ST1 if no event is occurring.

In Step ST7, the mode switcher 12 switches the operation modes of the mobile device 1. That is, in response to the determination made that each output of the preset number (predetermined number) of photoelectric converters 211 is a low output, the operation modes of the mobile device 1 can be switched. Here, for example, the notification mode is switched. In this case, for example, the notification mode may be switched from the normal mode to the vibration mode as illustrated in FIG. 15 to FIG. 17, or may be switched from the vibration mode to the silent mode as illustrated in FIG. 18 to FIG. 20. Further, for example, the notification mode may be switched from the normal mode to the silent mode as illustrated in FIG. 15, FIG. 16, and FIG. 20. With this, for example, a notification mode depending on the user's use condition can be realized.

In Step ST8, similarly to the above Steps ST1 and ST6, the controller 100 determines whether or not an event is occurring. Here, the process proceeds to Step ST9 if an event is occurring. Conversely, the process returns to Step ST1 if no event is occurring.

In Step ST9, similarly to the above Steps ST2 and ST4, the determination unit 11 recognizes a detected value related to the output of each photoelectric converter 211.

In Step ST10, the determination unit 11 determines whether or not the number of the photoelectric converters 211 each generating a low output is less than a preset number (predetermined number). Here, if the number of the photoelectric converters 211 each generating a low output is not less than the predetermined number, the process returns to Step ST8. Conversely, if the number of the photoelectric converters 211 each generating a low output is less than the predetermined number, the process proceeds to Step ST11.

In Step ST11, the mode switcher 12 switches the operation modes of the mobile device 1. Here, for example, switching of operation modes reverse to the switching of operation modes in Step ST7 can be performed. For example, one type of switching of the notification modes can be performed out of switching from the vibration mode to the normal mode, switching from the silent mode to the vibration mode, and switching from the silent mode to the normal mode. After the process of Step ST11 is ended, the process returns to Step ST1.

For example, such an operation flow may be repeatedly performed if the power of the mobile device 1 is on, and may be forcibly ended if the power of the mobile device 1 is off.

<(1-5) Gist of One Example of Embodiment>

As in the above, in one example of the embodiment, for example, concerning the plurality of photoelectric converters 211 that are adjacently located and generate power based on light incident on one surface of the outer package 4, operation modes of the mobile device 1 are switched when each output of a preset number of photoelectric converters 211 becomes a low output. With this, for example, the operation modes of the mobile device 1 can be switched depending on the conditions where the user uses the mobile device 1. As a result, the function of the mobile device 1 installed with the solar panel 210 as a solar cell can be improved.

<(2) Modifications>

For example, an event to be notified of may include incoming of various types of information, arrival of a set date and time, and occurrence of a situation to be paid attention to and the like, in addition to incoming of a call and email. The incoming of various types of information may include, for example, incoming of various types of information concerning updates of applications, warning against computer viruses, etc. The arrival of a set date and time may include arrival of a scheduled day in a schedule managing function, arrival of a set time in an alarm function and the like. The situation to be paid attention to may include, for example, a low remaining amount of power stored in a battery and a memory free space. Further, for example, if display of information on the display 120 is used for the notification of occurrence of an event, the mode switcher 12 may switch the display modes together with switching the notification modes.

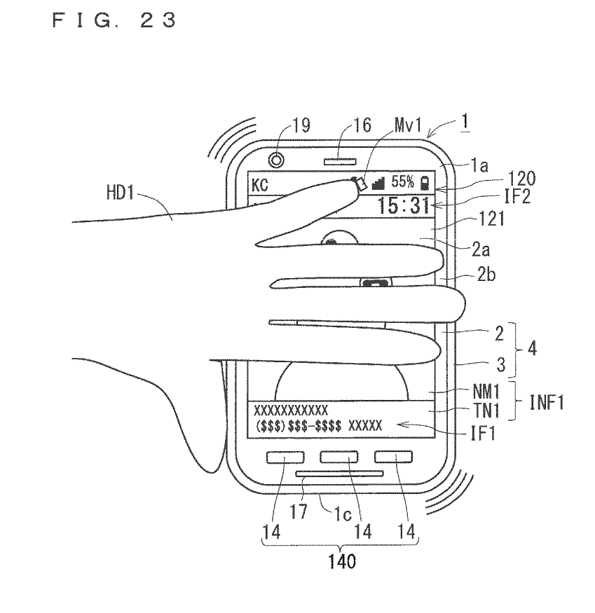

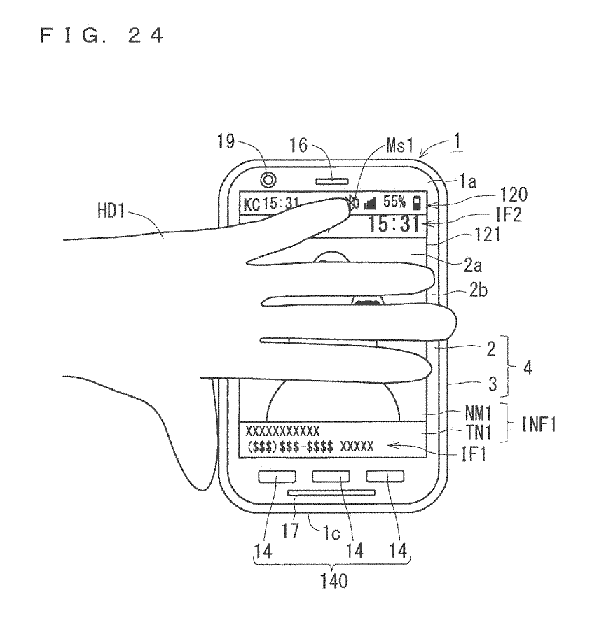

FIG. 23 and FIG. 24 illustrate one example of a state in which the display modes together with the notification modes are switched. FIG. 23 illustrates a state in which the information INF1 of a calling partner being important information IF1 is displayed in a part of the display screen 2a not shielded by the body of the user, clothes, items, etc. when modes are switched from the normal mode to the vibration mode. FIG. 24 illustrates a state in which the information INF1 of a calling partner being important information IF1 is displayed in a part of the display screen 2a not shielded by the user when modes are switched from the normal mode or from the vibration mode to the silent mode. Further, FIG. 23 and FIG. 24 illustrate a state in which an important type of information IF1 is displayed in a relatively large target display region, and another type of information IF2 is displayed in a relatively small target display region. With this, for example, information of the originator of the call is displayed while generation of sound or vibration for indicating an incoming call is prevented, when the user covers a part of the display screen 2a with a hand, a notebook, etc. during incoming of a voice call. Therefore, a mobile device 1 with good usability in a quiet environment, such as in an office, a library, and a train, can be provided.

Note that, for example, a configuration may be adopted in which the operation modes are switched when there is a notification of occurrence of an event such as incoming while the operation modes are not switched except the time when there is a notification.

Further, not limited to the notification of occurrence of an event such as incoming, for example, when at least a part of the display 120 is covered by a hand or the like and thereby the output generated correspondingly to light received at each one of a predetermined number of photoelectric converters 211 among the plurality of photoelectric converters 211 becomes a low output while music is output from the speaker 170, output modes may be switched in a manner that the output from the speaker 170 is interrupted or canceled or that the volume is reduced.

Further, when at least a part of the display 120 is covered by a hand or the like and thereby the output generated correspondingly to light received at each one of a predetermined number of photoelectric converters 211 among the plurality of photoelectric converters 211 becomes a low output, the brightness of the display screen 2a may be changed in a manner that the display screen 2a becomes darker.

Further, here, a case where light from the outside (also referred to as outside light) and light emitted by the display panel 121 (also referred to as self-emitting light) are incident on the solar panel 210 is assumed. In this case, if the self-emitting light has low intensity of a component in light that contributes to power generation of the solar panel 210, the output of the photoelectric converter 211 is easily lowered depending on shielding from the outside light. Therefore, for example, if a mode (also referred to as an eco-mode) is set in which intensity of self-emitting light is reduced in response to the setting of a state in which the operation mode of the mobile device 1 can be switched depending on the high and low of the output of the photoelectric converter 211, the output of the photoelectric converter 211 is easily lowered depending on shielding from outside light. As a result, switching of the operation modes of the mobile device 1 can be more securely controlled.

Further, for example, information need not be displayed in a part of the display screen 2a that cannot be seen from the user and is shielded from light because the mobile device 1 is put inside a pocket or the like. For example, if the display panel 121 employs a display panel such as an organic EL panel that can switch emission of light and non-emission of light per pixel, a configuration may be adopted in which light is not emitted in the region of the display screen 2a that cannot be seen from the user and is shielded from light such that information is not displayed in the region. With this, power consumption of the mobile device 1 can be reduced.

Further, as a manner of switching the operation modes, for example, the following manner may be adopted: a mode of a call (also referred to as a call mode) to be started in response to incoming is switched among a normal voice call mode, a hands-free voice call mode using the speaker 170 and the microphone 150, and a video call mode using a moving image. With this, the call mode to be started in response to incoming can be switched easily and promptly.

Further, when at least a part of the display 120 is covered by a hand or the like and thereby the output generated correspondingly to light received at each one of a predetermined number of photoelectric converters 211 among the plurality of photoelectric converters 211 becomes a low output during incoming, processing of at least one of putting the incoming on hold, playing a predetermined message, and playing predetermined music may be performed. Alternatively, the incoming may be disconnected.

Further, for example, whether or not the output of the photoelectric converter 211 is a low output may be determined based on covering over the photoelectric converter 211 with a part of the body such as a hand, in combination of detection of a hand performed by the touch panel 130 and the high and low of the output of each photoelectric converter 211. In this case, for example, a manner of switching the notification modes from the normal mode to the silent mode when the display screen 2a is covered by a hand during occurrence of incoming can be realized. Further, for example, it is also possible to realize a manner of switching the operation modes in which states can be switched from a state of notifying of occurrence of incoming to a state (also referred to as a hands-free call state) of making a hands-free call using the speaker 170 and the microphone 150, when a part of the display screen 2a is covered by a part other than the body in response to occurrence of incoming. That is, for example, switching of the operation modes can be realized depending on the type of what covers the display screen 2a. Note that, a part other than the body may include, for example, various objects such as clothes and stationary. Note that, for example, a mode before switching of operation modes may include a mode where a call is being made, and a mode after the switching of operation modes may include a mode where a call has ended

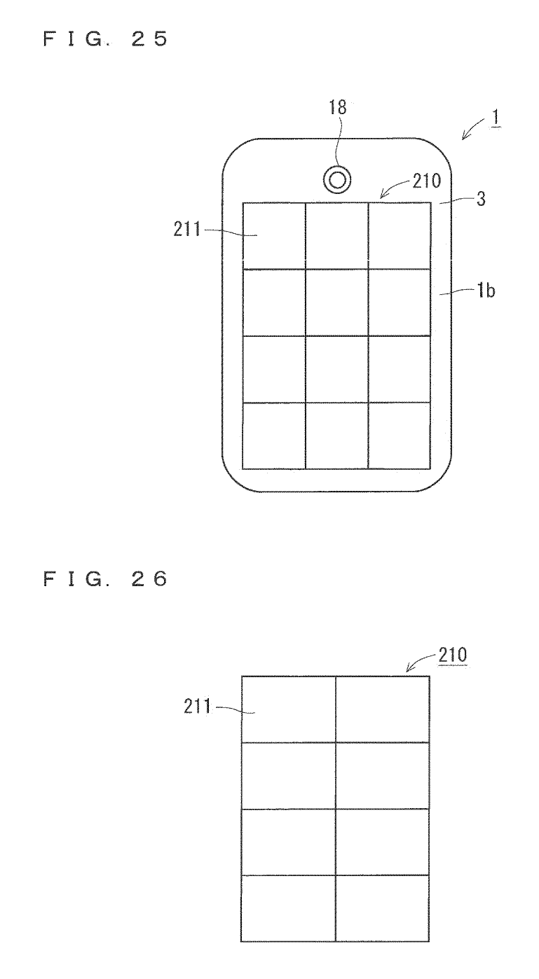

Further, for example, as illustrated in FIG. 25, a solar panel 210 may also be located on the back surface 1b being one surface that is different from the front surface 1a where the display 120 is located. Further, for example, a solar panel 210 may be located on the back surface 1b being one surface, in place of the solar panel 210 on the front surface 1a. Even with such a configuration, at least the notification modes can be switched.

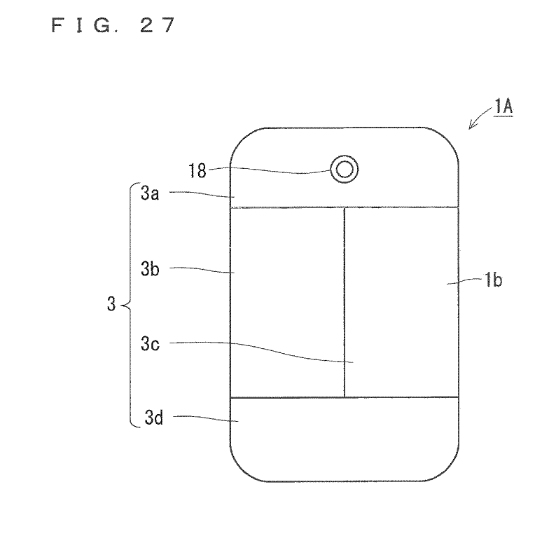

Further, for example, it is only necessary that the number of the plurality of photoelectric converters 211 that make up the solar panel 210 be two or more. Further, for example, as illustrated in FIG. 26, two photoelectric converters 211 may be located in each row. That is, the solar panel 210 may include a plurality of photoelectric converters 211, in which two photoelectric converters 211 are arrayed in a first direction and N (N being a natural number) photoelectric converters 211 are arrayed in a second direction that intersects the first direction. In one example of FIG. 26, the first direction and the second direction are orthogonal or substantially orthogonal to each other, and two photoelectric converters 211 are arrayed in the first direction and four photoelectric converters 211 are arrayed in the second direction. With such a configuration, all of the photoelectric converters 211 that make up the solar panel 210 can be arrayed along the outer periphery of the solar panel 210. With such a configuration, for example, wiring from each photoelectric converter 211 toward the power circuit 230 can be easily disposed.

Further, for example, as the notification unit 250, an external device such as a headset including headphones to be communicatively connected to the mobile device 1 may be applicable. The connection between the mobile device 1 and an external device may be either wired or wireless.

Further, for example, an integral device case 3 may be formed by directly or indirectly coupling a plurality of components as appropriate. A specific example of such a configuration will be described with one example of a mobile device 1A. FIG. 27 is a back view schematically illustrating one example of external appearance of the mobile device 1A. The mobile device 1A is, for example, a mobile phone such as a smartphone. In the mobile device 1A, for example, one device case 3 is formed of a plurality of modules 3a to 3d that are attached to the cover panel 2. In this case, as the module 3a, for example, a camera device with a built-in out-camera 180 can be adopted. As the module 3b, for example, a device for controlling the mobile device 1A with a built-in controller 100 can be adopted. As the module 3c, for example, a power device of the mobile device 1A with built-in power circuit 230 and battery 220 can be adopted. As the module 3d, for example, a device with another appropriate built-in configuration can be adopted.

With such a configuration, for example, a device for controlling the mobile device 1A, as the module 3b, includes the storage medium 103 that stores a program, and a processor such as a CPU and a DSP that executes the program. For example, the processor can execute switching processing of switching the operation modes of the mobile device 1. In the switching processing, the operation modes of the mobile device 1 are switched in response to a fact that the output generated correspondingly to light received at each one of a preset number of photoelectric converters 211 among the plurality of photoelectric converters 211 is a low output. Note that, the plurality of photoelectric converters 211 are adjacently located and can each generate power based on light incident on one surface of the outer package 4 of the mobile device 1A.

Note that, in the above, detailed description has been given of the mobile device 1, 1A, the method for controlling the mobile device 1, 1A, the device for controlling the mobile device 1, 1A, and the control program Pg1. However, the above description is in all aspects illustrative, and the present disclosure is not limited thereto. Further, needless to say, all or some of the components that constitute one example and various modifications of the above embodiment can be combined as appropriate unless there arises contradiction. Further, it is understood that numerous unillustrated modifications can be devised without departing from the scope of the present disclosure.

1. A mobile device comprising:
an outer package;
a plurality of photoelectric converters that are adjacently located and each generates power based on light incident on one surface of the outer package; and
at least one processor configured to switch operation modes of the mobile device in response to a fact that an output generated correspondingly to light received at each one of a preset number of photoelectric converters among the plurality of photoelectric converters is a low output that meets criterion conditions.

2. The mobile device according to claim 1, wherein the operation modes comprise an output mode of outputting information.

3. The mobile device according to claim 2, further comprising
a display that visibly outputs information, wherein
the output mode comprises a display mode of visibly outputting information on the display.

4. The mobile device according to claim 3, wherein
the display comprises a display panel located on a side of the one surface of the mobile device,
the plurality of photoelectric converters are transparent and are located on or above the display panel directly or with intermediation of another transparent layer, and
the at least one processor causes the display to display at least a specific type of information in a target display region other than a region where one or more photoelectric converters whose output is the low output among the plurality of photoelectric converters are stacked.

5. The mobile device according to claim 3, wherein
the display comprises a display panel located on a side of the one surface of the mobile device,
the plurality of photoelectric converters are transparent and are located on or above the display panel directly or with intermediation of another transparent layer, and the at least one processor causes the display to display at least a specific type of information in a target display region where, among the plurality of photoelectric converters, one or more photoelectric converters whose output is a high output that meets particular conditions are stacked.

6. The mobile device according to claim 4, wherein
if the target display region comprises two or more regions that are separated away from one another, the at least one processor causes the display to display at least the specific type of information in a region of the largest size among the two or more regions.

7. The mobile device according to claim 2, further comprising
a notification unit that notifies of occurrence of an event, wherein
the output mode comprises a notification mode of notifying of occurrence of an event with the notification unit.

8. The mobile device according to claim 7, wherein
the notification unit comprises a vibrator that vibrates a speaker that outputs sound and the outer package, and
the at least one processor switches a notification mode of notifying of occurrence of an event with sound output from the speaker to a notification mode of notifying of occurrence of an event with vibration of the outer package as obtained from the vibrator.

9. The mobile device according to claim 7, wherein
the notification unit comprises a speaker that outputs sound, and
the at least one processor switches a notification mode of notifying of occurrence of an event with sound output from the speaker to a notification mode of notifying of occurrence of an event with neither of sound nor vibration of the outer package.

10. The mobile device according to claim 7, wherein
the notification unit comprises a vibrator that vibrates the outer package, and
the at least one processor switches a notification mode of notifying of occurrence of an event with vibration of the outer package as obtained from the vibrator to a notification mode of notifying of occurrence of an event with neither of sound nor vibration of the outer package.

11. A method for controlling a mobile device comprising:
determining that an output generated correspondingly to light received at each one of a preset number of photoelectric converters among a plurality of photoelectric converters that are adjacently located and each of which generates power based on light incident on one surface of an outer package of the mobile device is a low output that meets criterion conditions; and
switching operation modes of the mobile device in response to determination made that each output of the preset number of photoelectric converters is the low output.

12. A device for controlling a mobile device, the device comprising:
a storage medium that stores a program; and
at least one processor configured to execute switching processing of switching operation modes of the mobile device by executing the program, in response to a fact that an output generated correspondingly to light received at each one of a preset number of photoelectric converters among a plurality of photoelectric converters that are adjacently located and each generate power based on light incident on one surface of an outer package of the mobile device is a low output that meets criterion conditions.

13. A non-transitory computer readable storage medium storing a control, wherein
the control program makes a mobile device:
determine that an output generated correspondingly to light received at each one of a preset number of photoelectric converters among a plurality of photoelectric converters that are adjacently located and each generate power based on light incident on one surface of an outer package of the mobile device is a low output that meets criterion conditions, and
switch operation modes of the mobile device in response to determination made that each output of the preset number of photoelectric converters is the low output.
